(19) United States
(12) Patent Application Publication
(10) Pub. No.: US 2024/0163701 A1
(43) Pub. Date: May 16, 2024

(54) DYNAMIC RECONFIGURATION AND CONCURRENT MEASUREMENT OF CROSS LINK INTERFERENCE MEASUREMENT RESOURCES

(71) Applicant: QUALCOMM Incorporated, San Diego, CA (US)

(72) Inventors: Huilin XU, Temecula, CA (US); Yuwei REN, Beijing (CN); Qunfeng HE, San Diego, CA (US)

(21) Appl. No.: 18/551,147

(22) PCT Filed: May 28, 2021
(86) PCT No.: PCT/CN2021/096625

§ 371 Date: Sep. 18, 2023

(51) Int. Cl. H04W 24/08; H04B 17/345; H04W 24/10

(52) U.S. Cl. CPC H04W 24/08; H04B 17/345; H04W 24/10

(57) ABSTRACT

A first user equipment (UE) receives, from a scheduling entity, one or more indications of one or more parameters associated with an uplink (UL) transmission from a second UE. The UL transmission includes one or more cross link interference (CLI) measurement resources. The first UE configures one or more dedicated tracking loops for receiving the one or more CLI measurement resources of the UL transmission based on the one or more indications of the one or more parameters. The first UE receives, from the second UE, the one or more CLI measurement resources of the UL transmission using the one or more dedicated tracking loops according to the one or more parameters, while also receiving a downlink (DL) transmission from the scheduling entity. The first UE determines one or more CLI measurements using the one or more CLI measurement resources of the UL transmission.

### TECHNICAL FIELD

The technology discussed below relates generally to wireless communication systems, and more particularly, to dynamic reconfiguration and concurrent measurement of cross link interference (CLI) measurement resources.

### INTRODUCTION

In wireless communication between a base station and user equipment (UE), simultaneous transmission and reception may be accomplished using different frequencies resources for uplink and downlink transmissions. This may be called frequency division duplexing (FDD). Additionally, or alternatively, simultaneous transmission and reception between a base station and a UE may be accomplished using different time resources for uplink (UL) and downlink (DL) transmissions. This may be called time division duplexing (TDD). Generally, FDD networks may have separate UL and DL frequency bands while TDD networks may utilize the same bandwidth, but may also allocate different time slots for UL and DL transmissions. Base station and UE transmissions may interference with each other creating cross link interference (CLI) when those transmissions occupy overlapping time slots in a same frequency band.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

A method of wireless communication at a first user equipment (UE) is provided. The method includes receiving, from a scheduling entity, one or more indications of one or more parameters associated with an uplink (UL) transmission from a second UE, wherein the UL transmission includes one or more cross link interference (CLI) measurement resources. The method also includes configuring one or more dedicated tracking loops for receiving the one or more CLI measurement resources of the UL transmission based on the one or more indications of the one or more parameters. The method further includes receiving, from the second UE, the one or more CLI measurement resources of the UL transmission using the one or more dedicated tracking loops according to the one or more parameters, while also receiving a downlink (DL) transmission from the scheduling entity. In addition, the method includes determining one or more CLI measurements using the one or more CLI measurement resources of the UL transmission.

In some aspects, the method further may include transmitting, to the scheduling entity, a CLI measurement report indicating the one or more CLI measurements associated with the one or more CLI measurement resources of the UL transmission. The one or more indications of the one or more parameters associated with the UL transmission may include at least one indication of one or more changed parameters associated with the UL transmission. The one or more parameters may include at least one of a power of at least one CLI measurement resource of the one or more CLI measurement resources, a frequency of at least one CLI measurement resource of the one or more CLI measurement resources, or a timing advance of at least one CLI measurement resource of the one or more CLI measurement resources. In some aspects, when the one or more parameters includes at least the power of the at least one CLI measurement resource of the one or more CLI measurement resources, the method may further include abstaining, for a predetermined duration of time, from receiving one or more CLI measurements using the at least one CLI measurement resources of the UL transmission when the power exceeds a threshold power difference from a previous power. The one or more indications of the one or more parameters may include a first indication of a first parameter associated with a first dedicated tracking loop of the one or more dedicated tracking loops, and a second indication of a second parameter associated with a second dedicated tracking loop of the one or more dedicated tracking loops.

In some aspects, the one or more indications of the one or more parameters may include at least one indication of a plurality of parameters associated with at least one dedicated tracking loop of the one or more dedicated tracking loops. The one or more indications of the one or more parameters associated with an UL transmission from a second UE may be received from the scheduling entity via at least one of a medium access control (MAC) control element (MAC-CE), a physical downlink control channel (PDCCH), or a radio resource control (RRC) message. The one or more indications may be included in transmission configuration indicator (TCI) state information. Each dedicated tracking loop of the one or more dedicated tracking loops may be associated with a single CLI measurement resource of the one or more CLI measurement resources. Each dedicated tracking loop of the one or more dedicated tracking loops may be associated with a plurality of CLI measurement resources of the one or more CLI measurement resources. The one or more parameters may be determined by the scheduling entity. The one or more parameters may be scheduled by the scheduling entity. The first UE may determine the one or more CLI measurements in response to receiving the one or more indications of the one or more parameters via a PDCCH. The one or more CLI measurements may include at least one of sound reference signal (SRS), a reference signal received strength (RSRP), or a received signal strength indicator (RSSI).

A first user equipment (UE) is provided. The first UE includes a transceiver for wirelessly communication, a memory, and a processor coupled to the transceiver and the memory. The processor and the memory are configured to receive, from a scheduling entity, one or more indications of one or more parameters associated with an uplink (UL) transmission from a second UE, wherein the UL transmission includes one or more cross link interference (CLI) measurement resources. The processor and the memory are also configured to configure one or more dedicated tracking loops for receiving the one or more CLI measurement resources of the UL transmission based on the one or more indications of the one or more parameters. The processor and the memory are further configured to receive, from the second UE, the one or more CLI measurement resources of the UL transmission using the one or more dedicated tracking loops according to the one or more parameters, while also receiving a downlink (DL) transmission from the scheduling entity. In addition, the processor and the memory are configured to determine one or more CLI measurements using the one or more CLI measurement resources of the UL transmission.

A non-transitory, processor-readable storage medium of a first user equipment (UE) is provided. The non-transitory, processor-readable storage medium has instructions stored thereon. When the instructions are executed by a processing circuit, the instructions cause the processing circuit to receive, from a scheduling entity, one or more indications of one or more parameters associated with an uplink (UL) transmission from a second UE, wherein the UL transmission includes one or more cross link interference (CLI) measurement resources. When the instructions are executed by a processing circuit, the instructions also cause the processing circuit to configure one or more dedicated tracking loops for receiving the one or more CLI measurement resources of the UL transmission based on the one or more indications of the one or more parameters. When the instructions are executed by a processing circuit, the instructions further cause the processing circuit to receive, from the second UE, the one or more CLI measurement resources of the UL transmission using the one or more dedicated tracking loops according to the one or more parameters, while also receiving a downlink (DL) transmission from the scheduling entity. In addition, when the instructions are executed by a processing circuit, the instructions cause the processing circuit to determine one or more CLI measurements using the one or more CLI measurement resources of the UL transmission.

A first UE is provided. The first UE includes means for receiving, from a scheduling entity, one or more indications of one or more parameters associated with an uplink (UL) transmission from a second UE, wherein the UL transmission includes one or more cross link interference (CLI) measurement resources. The first UE also includes means for configuring one or more dedicated tracking loops for receiving the one or more CLI measurement resources of the UL transmission based on the one or more indications of the one or more parameters. The first UE further includes means for receiving, from the second UE, the one or more CLI measurement resources of the UL transmission using the one or more dedicated tracking loops according to the one or more parameters, while also receiving a downlink (DL) transmission from the scheduling entity. In addition, the first UE includes means for determining one or more CLI measurements using the one or more CLI measurement resources of the UL transmission.

A method of wireless communication at a scheduling entity is provided. The method includes determining one or more parameters associated with an uplink (UL) transmission from a second user equipment (UE), wherein the UL transmission includes one or more cross link interference (CLI) measurement resources. The method also includes transmitting, to a first UE, one or more indications of the one or more parameters associated with the UL transmission for configuring one or more dedicated tracking loops for receiving the one or more CLI measurement resources of the UL transmission. The method further includes transmitting, to the first UE, a downlink (DL) transmission while the second UE transmits the UL transmission. In addition, the method includes receiving a measurement report from the first UE including one or more CLI measurements obtained from the one or more CLI measurement resources associated with the UL transmission.

In some aspects, the one or more indications of the one or more parameters associated with the UL transmission may include at least one indication of one or more changed parameters associated with the UL transmission. The one or more parameters may include at least one of a power of at least one CLI measurement resource of the one or more CLI measurement resources, a frequency of at least one CLI measurement resource of the one or more CLI measurement resources, or a timing advance of at least one CLI measurement resource of the one or more CLI measurement resources. The one or more indications of the one or more parameters may include a first indication of a first parameter associated with a first dedicated tracking loop of the one or more dedicated tracking loops, and a second indication of a second parameter associated with a second dedicated tracking loop of the one or more dedicated tracking loops. The one or more indications of the one or more parameters may include at least one indication of a plurality of parameters associated with at least one dedicated tracking loop of the one or more dedicated tracking loops. The one or more indications of the one or more parameters associated with an UL transmission from a second UE may be transmitted by the scheduling entity via at least one of a medium access control (MAC) control element (MAC-CE), a physical downlink control channel (PDCCH), or a radio resource control (RRC) message.

In some aspects, the one or more indications may be included in transmission configuration indicator (TCI) state information. Each dedicated tracking loop of the one or more dedicated tracking loops may be associated with a single CLI measurement resource of the one or more CLI measurement resources. Each dedicated tracking loop of the one or more dedicated tracking loops may be associated with a plurality of CLI measurement resources of the one or more CLI measurement resources. Determining the one or more parameters associated with the UL transmission may include scheduling the one or more parameters associated with the UL transmission. Transmitting the one or more indications of the one or more parameters to the first UE may trigger the first UE to determine the one or more CLI measurements. The one or more CLI measurements may include at least one of sound reference signal (SRS), a reference signal received strength (RSRP), or a received signal strength indicator (RSSI).

A scheduling entity is provided. The scheduling entity includes a transceiver for wirelessly communication, a memory, and a processor coupled to the transceiver and the memory. The processor and the memory are configured to determine one or more parameters associated with an uplink (UL) transmission from a second user equipment (UE), wherein the UL transmission includes one or more cross link interference (CLI) measurement resources. The processor and the memory are also configured to transmit, to a first UE, one or more indications of the one or more parameters associated with the UL transmission for configuring one or more dedicated tracking loops for receiving the one or more CLI measurement resources of the UL transmission. The processor and the memory are further configured to transmit, to the first UE, a downlink (DL) transmission while the second UE transmits the UL transmission. In addition, the processor and the memory are configured to receive a measurement report from the first UE including one or more CLI measurements obtained from the one or more CLI measurement resources associated with the UL transmission.

A non-transitory, processor-readable storage medium of a scheduling entity is provided. The non-transitory, processor-readable storage medium has instructions stored thereon. When the instructions are executed by a processing circuit, the instructions cause the processing circuit to determine one or more parameters associated with an uplink (UL) transmission from a second user equipment (UE), wherein the UL transmission includes one or more cross link interference (CLI) measurement resources. When the instructions are executed by a processing circuit, the instructions also cause the processing circuit to transmit, to a first UE, one or more indications of the one or more parameters associated with the UL transmission for configuring one or more dedicated tracking loops for receiving the one or more CLI measurement resources of the UL transmission. When the instructions are executed by a processing circuit, the instructions further cause the processing circuit to transmit, to the first UE, a downlink (DL) transmission while the second UE transmits the UL transmission. In addition, when the instructions are executed by a processing circuit, the instructions cause the processing circuit to receive a measurement report from the first UE including one or more CLI measurements obtained from the one or more CLI measurement resources associated with the UL transmission.

A scheduling entity is provided. The scheduling entity includes means for determining one or more parameters associated with an uplink (UL) transmission from a second user equipment (UE), wherein the UL transmission includes one or more cross link interference (CLI) measurement resources. The scheduling entity also includes means for transmitting, to a first UE, one or more indications of the one or more parameters associated with the UL transmission for configuring one or more dedicated tracking loops for receiving the one or more CLI measurement resources of the UL transmission. The scheduling entity further includes means for transmitting, to the first UE, a downlink (DL) transmission while the second UE transmits the UL transmission. In addition, the scheduling entity includes means for receiving a measurement report from the first UE including one or more CLI measurements obtained from the one or more CLI measurement resources associated with the UL transmission.

A method of wireless communication at a first user equipment (UE) is provided. The method includes determining that a plurality of cross link interference (CLI) measurement resources is within a same CLI measurement resource group of one or more CLI measurement resource groups. The method also includes receiving at least two CLI measurement resources of the plurality of CLI measurement resources in one or more same symbols of at least two concurrent uplink (UL) transmissions using at least one dedicated tracking loop, while also receiving a downlink (DL) transmission from a scheduling entity. The method further includes determining one or more CLI measurements for the at least two CLI measurement resources based on the at least two CLI measurement resources being received in the one or more same symbols of the at least two concurrent UL transmissions and being within the same CLI measurement resource group of the one or more CLI measurement resource groups.

In some aspects, determining that the plurality of measurement resources is within the CLI measurement resource group may include receiving one or more indications from the scheduling entity that the plurality of measurement resources is within the CLI measurement resource group. Determining that the plurality of measurement resources is within the CLI measurement resource group may include receiving, from the scheduling entity, an indication of one or more common parameters of the CLI measurement resource group, and determining that the plurality of measurement resources is within the CLI measurement resource group based on the one or more common parameters. the one or more common parameters may include at least one of a same or similar power, a same or similar timing, or a same or similar frequency. The at least one dedicated tracking loop may include only one dedicated tracking loop dedicated to the CLI measurement group. The at least one dedicated tracking loop may include at least two dedicated tracking loops, and wherein receiving the at least two CLI measurement resources of the plurality of CLI measurement resources in the one or more same symbols of at least two concurrent UL transmissions may include at least receiving a first CLI measurement resource of the plurality of CLI measurement resources using a first dedicated tracking loop while receiving the DL transmission from the scheduling entity, and receiving a second CLI measurement resource of the plurality of CLI measurement resources using a second dedicated tracking loop while receiving the DL transmission from the scheduling entity. The method may further include transmitting an indication that the first UE supports concurrent reception of the plurality of CLI measurement resources using a plurality of dedicated tracking loops. The indication that the first UE supports concurrent reception of the plurality of CLI measurement resources using the plurality of dedicated tracking loops may include an indication of a maximum quantity of dedicated tracking loops of the first UE for receiving the plurality of CLI measurement resources. The indication that the first UE supports concurrent reception of the plurality of CLI measurement resources using the plurality of dedicated tracking loops may include an indication of a maximum quantity of same symbols of the one or more symbols that each of the at least two dedicated tracking loops of the first UE are configured to utilize for receiving the plurality of CLI measurement resources.

In some aspects, determining that the plurality of CLI measurement resources is within the same CLI measurement resource group of the one or more CLI measurement resource groups may include at least determining that a first plurality of CLI measurement resources are within a first same CLI measurement resource group of the one or more CLI measurement resource groups, and determining that a second plurality of CLI measurement resources are within a second same CLI measurement resource group of the one or more CLI measurement resource groups. The method may further include determining that a quantity of CLI measurement resource groups exceeds a reception capability of the first UE, determining a first priority value of the first same CLI measurement resource group and a second priority value of the second same CLI measurement resource group, selecting either the first same CLI measurement resource group or the second same CLI measurement resource group based on whether the first priority value or the second priority value is a greater value, and receiving either the first same CLI measurement resource group or the second same CLI measurement resource group in the one or more same symbols of at least two concurrent UL transmissions using at least one dedicated tracking loop while receiving a downlink (DL) transmission from a scheduling entity based on whether the first priority value or the second priority value is selected. The first priority value and the second priority value may be assigned by the scheduling entity or determined by the first UE. The first priority value and the second priority value may be determined based on a first distance between the first UE and first source of a first concurrent UL transmission of the at least two concurrent UL transmissions and on a second distance between the first UE and second source of a second concurrent UL transmission of the at least two concurrent UL transmissions. The first priority value may be based on a first power of a first concurrent UL transmission of the at least two concurrent UL transmissions, and wherein the second priority value may be based on a second power of a second concurrent UL transmission of the at least two concurrent UL transmissions.

A first user equipment (UE) is provided. The first UE includes a transceiver for wirelessly communication, a memory, and a processor coupled to the transceiver and the memory. The processor and the memory are configured to determine that a plurality of cross link interference (CLI) measurement resources is within a same CLI measurement resource group of one or more CLI measurement resource groups. The processor and the memory are also configured to receive at least two CLI measurement resources of the plurality of CLI measurement resources in one or more same symbols of at least two concurrent uplink (UL) transmissions using at least one dedicated tracking loop, while also receiving a downlink (DL) transmission from a scheduling entity. The processor and the memory are further configured to determine one or more CLI measurements for the at least two CLI measurement resources based on the at least two CLI measurement resources being received in the one or more same symbols of the at least two concurrent UL transmissions and being within the same CLI measurement resource group of the one or more CLI measurement resource groups.

A non-transitory, processor-readable storage medium of a first user equipment (UE) is provided. The non-transitory, processor-readable storage medium has instructions stored thereon. When the instructions are executed by a processing circuit, the instructions cause the processing circuit to determine that a plurality of cross link interference (CLI) measurement resources is within a same CLI measurement resource group of one or more CLI measurement resource groups. When the instructions are executed by a processing circuit, the instructions also cause the processing circuit to receive at least two CLI measurement resources of the plurality of CLI measurement resources in one or more same symbols of at least two concurrent uplink (UL) transmissions using at least one dedicated tracking loop, while also receiving a downlink (DL) transmission from a scheduling entity. When the instructions are executed by a processing circuit, the instructions further cause the processing circuit to determine one or more CLI measurements for the at least two CLI measurement resources based on the at least two CLI measurement resources being received in the one or more same symbols of the at least two concurrent UL transmissions and being within the same CLI measurement resource group of the one or more CLI measurement resource groups.

A first user equipment (UE) is provided. The first UE includes means for determining that a plurality of cross link interference (CLI) measurement resources is within a same CLI measurement resource group of one or more CLI measurement resource groups. The first UE also includes means for receiving at least two CLI measurement resources of the plurality of CLI measurement resources in one or more same symbols of at least two concurrent uplink (UL) transmissions using at least one dedicated tracking loop, while also receiving a downlink (DL) transmission from a scheduling entity. The first UE further includes means for determining one or more CLI measurements for the at least two CLI measurement resources based on the at least two CLI measurement resources being received in the one or more same symbols of the at least two concurrent UL transmissions and being within the same CLI measurement resource group of the one or more CLI measurement resource groups.

A method of wireless communication at a scheduling entity is provided. The method includes transmitting an indication to a first use equipment (UE) that a plurality of cross link interference (CLI) measurement resources is within a same CLI measurement resource group of one or more CLI measurement resource groups. The method also includes transmitting a downlink (DL) transmission to the first UE when the first UE receives at least two CLI measurement resources of the plurality of CLI measurement resources in one or more same symbols of at least two concurrent uplink (UL) transmissions using at least one dedicated tracking loop. The method further includes receiving a CLI measurement report including one or more CLI measurements for the at least two CLI measurement resources based on the at least two CLI measurement resources being received in the one or more same symbols of the at least two concurrent UL transmissions and being within the same CLI measurement resource group of the one or more CLI measurement resource groups.

In some aspects, transmitting the indication to the first UE that the plurality of CLI measurement resources is within the same CLI measurement resource group of the one or more CLI measurement resource groups may include transmitting, to the first UE, an indication of one or more common parameters of the CLI measurement resource group for the first UE to determine that the plurality of measurement resources is within the CLI measurement resource group based on the one or more common parameters. The one or more common parameters may include at least one of a same or similar power, a same or similar timing, or a same or similar frequency. The at least one dedicated tracking loop may include only one dedicated tracking loop dedicated to the CLI measurement group. The at least one dedicated tracking loop may include at least two dedicated tracking loops, and wherein the at least two CLI measurement resources of the plurality of CLI measurement resources in the one or more same symbols of at least two concurrent UL transmissions may include at least a first CLI measurement resource of the plurality of CLI measurement resources for reception by a first dedicated tracking loop, and a second CLI measurement resource of the plurality of CLI measurement resources for reception by a second dedicated tracking loop.

In some aspects, the method may further include receiving, from the first UE, an indication that the first UE supports concurrent reception of the plurality of CLI measurement resources using a plurality of dedicated tracking loops. The indication that the first UE supports concurrent reception of the plurality of CLI measurement resources using the plurality of dedicated tracking loops may include an indication of a maximum quantity of dedicated tracking loops of the first UE for receiving the plurality of CLI measurement resources. The indication that the first UE supports concurrent reception of the plurality of CLI measurement resources using the plurality of dedicated tracking loops may include an indication of a maximum quantity of same symbols of the one or more symbols that each of the at least two dedicated tracking loops of the first UE are configured to utilize for receiving the plurality of CLI measurement resources. The indication to the first UE that the plurality of CLI measurement resources is within the same CLI measurement resource group of one or more CLI measurement resource groups may include at least that a first plurality of CLI measurement resources is within a first same CLI measurement resource group of the one or more CLI measurement resource groups, and a second plurality of CLI measurement resources are within a second same CLI measurement resource group of the one or more CLI measurement resource groups. The one or more CLI measurements may be based on a first priority value of the first same CLI measurement resource group and a second priority value of the second same CLI measurement resource group. The first priority value and the second priority value may be assigned by the scheduling entity or determined by the first UE. The first priority value and the second priority value may be determined based on a first distance between the first UE and first source of a first concurrent UL transmission of the at least two concurrent UL transmissions and on a second distance between the first UE and second source of a second concurrent UL transmission of the at least two concurrent UL transmissions. The first priority value may be based on a first power of a first concurrent UL transmission of the at least two concurrent UL transmissions, and the second priority value may be based on a second power of a second concurrent UL transmission of the at least two concurrent UL transmissions.

A scheduling entity is provided. The scheduling entity includes a transceiver for wirelessly communication, a memory, and a processor coupled to the transceiver and the memory. The processor and the memory are configured to transmit an indication to a first use equipment (UE) that a plurality of cross link interference (CLI) measurement resources is within a same CLI measurement resource group of one or more CLI measurement resource groups. The processor and the memory are also configured to transmit a downlink (DL) transmission to the first UE when the first UE receives at least two CLI measurement resources of the plurality of CLI measurement resources in one or more same symbols of at least two concurrent uplink (UL) transmissions using at least one dedicated tracking loop. The processor and the memory are further configured to receive a CLI measurement report including one or more CLI measurements for the at least two CLI measurement resources based on the at least two CLI measurement resources being received in the one or more same symbols of the at least two concurrent UL transmissions and being within the same CLI measurement resource group of the one or more CLI measurement resource groups.

A non-transitory, processor-readable storage medium of a scheduling entity is provided. The non-transitory, processor-readable storage medium has instructions stored thereon. When the instructions are executed by a processing circuit, the instructions cause the processing circuit to transmit an indication to a first use equipment (UE) that a plurality of cross link interference (CLI) measurement resources is within a same CLI measurement resource group of one or more CLI measurement resource groups. When the instructions are executed by a processing circuit, the instructions also cause the processing circuit to transmit a downlink (DL) transmission to the first UE when the first UE receives at least two CLI measurement resources of the plurality of CLI measurement resources in one or more same symbols of at least two concurrent uplink (UL) transmissions using at least one dedicated tracking loop. When the instructions are executed by a processing circuit, the instructions further cause the processing circuit to receive a CLI measurement report including one or more CLI measurements for the at least two CLI measurement resources based on the at least two CLI measurement resources being received in the one or more same symbols of the at least two concurrent UL transmissions and being within the same CLI measurement resource group of the one or more CLI measurement resource groups.

A scheduling entity is provided. The scheduling entity includes means for transmitting an indication to a first use equipment (UE) that a plurality of cross link interference (CLI) measurement resources is within a same CLI measurement resource group of one or more CLI measurement resource groups. The scheduling entity also includes means for transmitting a downlink (DL) transmission to the first UE when the first UE receives at least two CLI measurement resources of the plurality of CLI measurement resources in one or more same symbols of at least two concurrent uplink (UL) transmissions using at least one dedicated tracking loop. The scheduling entity further includes means for receiving a CLI measurement report including one or more CLI measurements for the at least two CLI measurement resources based on the at least two CLI measurement resources being received in the one or more same symbols of the at least two concurrent UL transmissions and being within the same CLI measurement resource group of the one or more CLI measurement resource groups.

These and other aspects of the invention will become more fully understood upon a review of the detailed description, which follows. Other aspects, features, and embodiments will become apparent to those of ordinary skill in the art, upon reviewing the following description of specific, exemplary embodiments in conjunction with the accompanying figures. While features may be discussed relative to certain embodiments and figures below, all embodiments can include one or more of the advantageous features discussed herein. In other words, while one or more embodiments may be discussed as having certain advantageous features, one or more of such features may also be used in accordance with the various embodiments discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 is a schematic illustration of a wireless communication system according to some aspects.

FIG. 2 is a conceptual illustration of an example of a radio access network according to some aspects.

FIG. 3 is a block diagram illustrating a wireless communication system supporting multiple-input multiple-output (MIMO) communication according to some aspects.

FIG. 4 is a diagram illustrating an example of communication between a base station and at least two user equipment (UEs) using beamforming according to some aspects.

FIG. 5 is a schematic illustration of an organization of wireless resources in an air interface utilizing orthogonal frequency divisional multiplexing (OFDM) according to some aspects.

FIG. 6 is a schematic illustration of an OFDM air interface utilizing a scalable numerology according to some aspects.

FIG. 7 is a conceptual diagram illustrating an example environment for concurrent measurement of multiple CLI measurement resources according to some aspects.

FIG. 8A is a conceptual diagram illustrating an example environment for dynamic reconfiguration of CLI measurement resources according to some aspects.

FIG. 8B is a conceptual diagram illustrating an example of a configuration of a CLI measurement resource according to some aspects.

FIG. 9 is a block diagram conceptually illustrating an example of a hardware implementation for a scheduling entity according to some aspects.

FIG. 10 is a flow chart of a method for dynamic reconfiguration of CLI measurement resources according to some aspects.

FIG. 11 is a flow chart of a method for concurrent measurement of multiple CLI measurement resources according to some aspects.

FIG. 12 is a block diagram conceptually illustrating an example of a hardware implementation for a user equipment (UE) according to some aspects of the disclosure.

FIG. 13 is a flow chart of a method for dynamic reconfiguration of CLI measurement resources according to some aspects.

FIG. 14 is a flow chart of a method for concurrent measurement of multiple CLI measurement resources according to some aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

In wireless communication between a base station and user equipment (UE), simultaneous transmission and reception may be accomplished using different frequencies resources for uplink and downlink transmissions. This may be called frequency division duplexing (FDD). Additionally, or alternatively, simultaneous transmission and reception between a base station and a UE may be accomplished using different time resources for uplink (UL) and downlink (DL) transmissions. This may be called time division duplexing (TDD). Generally, FDD networks may have separate UL and DL frequency bands while TDD networks may utilize the same bandwidth, but may also allocate different time slots for UL and DL transmissions. Base station and UE transmissions may interference with each other creating cross link interference (CLI) when those transmissions occupy overlapping time slots in a same frequency band.

In some aspects, CLI may occur when a network configures different TDD UL transmission and DL transmission slot formats to nearby user equipment (UEs). When an aggressor UE is transmitting an UL transmission, a victim UE may receive the UL transmission as CLI in the DL symbols if the aggressor UE's UL symbol collides with at least one DL symbol of the victim UE. In some aspects, CLI may occur between two or more UEs on the same cell or on different cells. In Release-16 New Radio (NR), the signaling procedure for a victim UE may be to measure CLI from an aggressor UE. The aggressor UE may not transmit a slot that is dedicated for CLI measurement by a victim UE and may not be aware that its UL transmission is measured by the victim UE. The network may configure one or more CLI measurement resources for the victim UE to measure the CLI of the UL transmission from the aggressor UE. After recording (e.g., measuring) one or more CLI measurements using the one or more CLI measurement resources of the UL transmission from the aggressor UE, the victim UE may transmit a CLI measurement report containing the one or more CLI measurements to the network so that the network may manage the scheduling of the aggressor UE and the victim UE to balance the throughput of both the aggressor UE and the victim UE.

In some aspects, a victim UE may not need to receive concurrent serving cell DL signals/channels (such as serving cell physical downlink control channel (PDCCH), physical downlink shared channel (PDSCH), and channel state information (CSI) reference signal (CSI-RS) for channel state feedback (CSF) and beam management) together with CLI measurement resource in the same symbol. If a configured CLI measurement resource collides with serving cell DL signals/channels in time domain, the victim UE should receive the CLI measurement resource and skip the serving cell DL signals/channels. For example, the CLI measurement resource by nature may have a different timing from the serving cell DL signals/channels. Separate fast Fourier transform (FFT) window timings may be required to receive both the CLI measurement resource and serving cell DL signals/channels. Supporting two FFT windows in a same symbol may not be preferrable to UE implementation. In some aspects, prioritizing a CLI resource by higher layer configuration over dynamically scheduled DL channels/signals as well as prioritizing PDCCH over CLI measurement may be a simpler (e.g., semi-static) operation. It should be noted that besides timing, frequency and power may be very different between serving cell DL signals/channels and CLI measurement resource. Relative speed vector between a victim UE and an aggressor UE may be different from relative speed vector between a victim UE and base station. DL signal power may be different from the UL transmission power of an aggressor UE. However, currently, the victim UE may use its DL tracking loops to receive CLI.

In some aspects, a victim UE may receive CLI measurement resources from different sources concurrently. For example, a victim UE may receive an UL transmission from two or more different aggressor UEs within a same cell or within different cells. A victim UE may measure every CLI measurement resource even if CLI measurement resource from different sources are configured in a same symbol. In some aspects, because all CLI measurement resources may be received using a victim UE's tracking loops for serving cell DL signals/channels, a victim UE may not be able to concurrently receive multiple CLI measurement resources. Instead, CLI measurement resources may be indistinguishable from the perspective of the victim UE's receiver tracking loop potentially creating sub-optimal measurement accuracy of the CLI measurement.

In some aspects, to improve CLI measurement accuracy, dedicated tracking loops (e.g., an automatic gain control (AGC) tracking loop, a time tracking loop (TTL), a frequency tracking loop (FTL)) may be used to measure CLI measurement resources. Using dedicated tracking loops, a victim UE may be able to distinguish between different CLI measurement resource based on differences in power, timing, frequency, and the like. In some aspects, a network may indicate to a victim UE that certain properties of a CLI measurement resource are sufficiently different so that the victim UE may use different tracking loops to receive these CLI measurement resources.

In some aspects, a victim UE may assume that no dedicated tracking loops are used for CLI measurement. For example, a reception (RX) timing of a CLI resource may be a same timing as a victim UE's transmission (TX) timing. As another example, an FTL and an AGC of a server cell DL signal/channel RX may be reused for CLI measurement. In some cases, a CLI that is 10 dB weaker than serving cell PDSCH may cap the carrier to interference plus noise ratio (CINR) at 10 dB and the corresponding maximum modulation and coding scheme (MCS). In some cases, when at a cell edge, a CLI may be even stronger than the serving cell PDSCH. For both cases, the CLI measurement accuracy may be impacted if a same AGC is used to receive the CLI due to either serious truncation or saturation of the CLI resource. In some aspects, the victim UE may not even be able to identify the sequence if the CLI resource is a sounding reference signal (SRS).

To avoid this problem, dedicated tracking loops may be used for CLI measurement. Unlike network serving cell DL signals (e.g., CSI-RS, synchronization signal block (SSB)), a CLI measurement resource from the aggressor UE may have an abrupt change. For example, a sharp change of CLI power may be due to an aggressor UE's dynamic TX power sharing for UL carrier aggregation (CA) or dynamic TX power aggregation. An abrupt frequency change may be due to TX frequency pre-compensation of an aggressor UE in high-speed train (HST) scenario when the aggressor UE passes by the remote radio head (RRH). In some aspects, TX timing advance of an aggressor UE may also jump due to a timing advance (TA) adjustment. However, to enable a victim UE's dedicated tracking loops to smoothly track the timing, frequency, and power of CLI and quickly converge, a network can configure the timing, frequency, and gain information to victim UE whenever there is an abrupt change.

While aspects and embodiments are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, embodiments and/or uses may come about via integrated chip embodiments and other non-module-component based devices (e.g., end-user devices, vehicles, communication devices, computing devices, industrial equipment, retail/purchasing devices, medical devices, AI-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or OEM devices or systems incorporating one or more aspects of the described innovations. In some practical settings, devices incorporating described aspects and features may also necessarily include additional components and features for implementation and practice of claimed and described embodiments. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes and constitution.

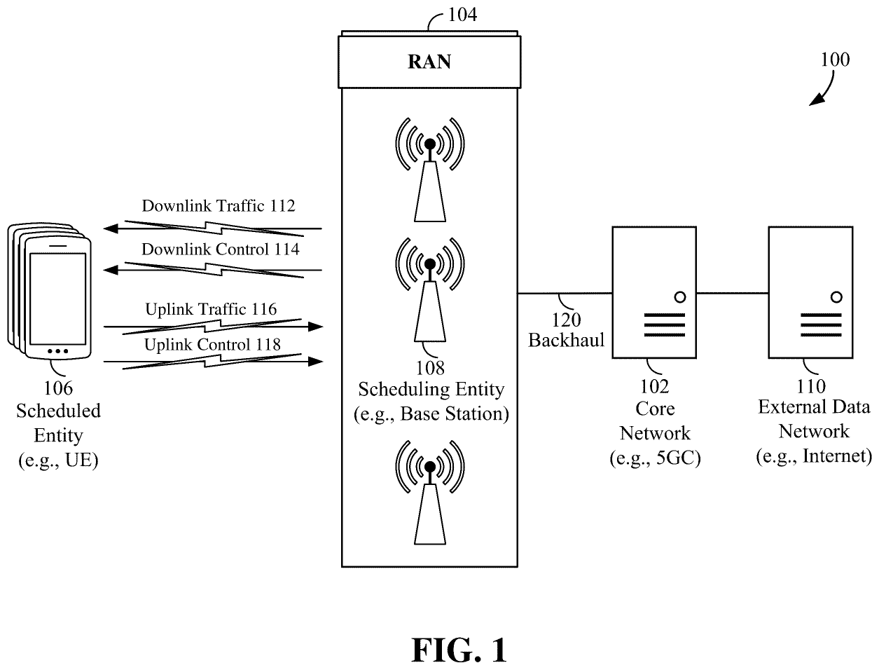

The various concepts presented throughout this disclosure may be implemented across a broad variety of telecommunication systems, network architectures, and communication standards. Referring now to FIG. 1, as an illustrative example without limitation, various aspects of the present disclosure are illustrated with reference to a wireless communication system 100. The wireless communication system 100 includes three interacting domains: a core network 102, a radio access network (RAN) 104, and a user equipment (UE) 106. By virtue of the wireless communication system 100, the UE 106 may be enabled to carry out data communication with an external data network 110, such as (but not limited to) the Internet.

The RAN 104 may implement any suitable wireless communication technology or technologies to provide radio access to the UE 106. As one example, the RAN 104 may operate according to 3rd Generation Partnership Project (3GPP) New Radio (NR) specifications, often referred to as 5G. As another example, the RAN 104 may operate under a hybrid of 5G NR and Evolved Universal Terrestrial Radio Access Network (eUTRAN) standards, often referred to as Long-Term Evolution (LTE). The 3GPP refers to this hybrid RAN as a next-generation RAN, or NG-RAN. Of course, many other examples may be utilized within the scope of the present disclosure.

As illustrated, the RAN 104 includes a plurality of base stations 108 (e.g., a RAN entity, RAN node, or the like). Broadly, a base station is a network element in a radio access network responsible for radio transmission and reception in one or more cells to or from a UE. In different technologies, standards, or contexts, a base station may variously be referred to by those skilled in the art as a base transceiver station (BTS), a radio base station, a radio transceiver, a transceiver function, a basic service set (BSS), an extended service set (ESS), an access point (AP), a Node B (NB), an eNode B (eNB), a gNode B (gNB), a transmission and reception point (TRP), or some other suitable terminology. In some examples, a base station may include two or more TRPs that may be collocated or non-collocated. Each TRP may communicate on the same or different carrier frequency within the same or different frequency band.

The radio access network 104 is further illustrated supporting wireless communication for multiple mobile apparatuses. A mobile apparatus may be referred to as user equipment (UE) in 3GPP standards, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus that provides a user with access to network services.

Within the present document, a “mobile” apparatus need not necessarily have a capability to move and may be stationary. The term mobile apparatus or mobile device broadly refers to a diverse array of devices and technologies. UEs may include a number of hardware structural components sized, shaped, and arranged to help in communication; such components can include antennas, antenna arrays, RF chains, amplifiers, one or more processors, etc. electrically coupled to each other. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of Things” (IoT). A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, an industrial automation and enterprise device, a logistics controller, agricultural equipment, etc. Still further, a mobile apparatus may provide for connected medicine or telemedicine support, e.g., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

Wireless communication between a RAN 104 and a UE 106 may be described as utilizing an air interface. Transmissions over the air interface from a base station (e.g., base station 108) to one or more UEs (e.g., UE 106) may be referred to as downlink (DL) transmission. In accordance with certain aspects of the present disclosure, the term downlink may refer to a point-to-multipoint transmission originating at a scheduling entity (described further below; e.g., base station 108). Another way to describe this scheme may be to use the term broadcast channel multiplexing. Transmissions from a UE (e.g., UE 106) to a base station (e.g., base station 108) may be referred to as uplink (UL) transmissions. In accordance with further aspects of the present disclosure, the term uplink may refer to a point-to-point transmission originating at a scheduled entity (described further below; e.g., UE 106).

In some examples, access to the air interface may be scheduled, wherein a scheduling entity (e.g., a base station 108) allocates resources for communication among some or all devices and equipment within its service area or cell. Within the present disclosure, as discussed further below, the scheduling entity may be responsible for scheduling, assigning, reconfiguring, and releasing resources for one or more scheduled entities. That is, for scheduled communication, UEs 106, which may be scheduled entities, may utilize resources allocated by the scheduling entity 108.

As illustrated in FIG. 1, a scheduling entity 108 may broadcast downlink traffic 112 to one or more scheduled entities 106. Broadly, the scheduling entity 108 is a node or device responsible for scheduling traffic in a wireless communication network, including the downlink traffic 112 and, in some examples, uplink traffic 116 from one or more scheduled entities 106 to the scheduling entity 108. On the other hand, the scheduled entity 106 is a node or device that receives downlink control information 114, including but not limited to scheduling information (e.g., a grant), synchronization or timing information, or other control information from another entity in the wireless communication network such as the scheduling entity 108.

In addition, the uplink and/or downlink control information and/or traffic information may be time-divided into frames, subframes, slots, and/or symbols. As used herein, a symbol may refer to a unit of time that, in an orthogonal frequency division multiplexed (OFDM) waveform, carries one resource element (RE) per sub-carrier. A slot may carry 7 or 14 OFDM symbols. A subframe may refer to a duration of 1 ms. Multiple subframes or slots may be grouped together to form a single frame or radio frame. Of course, these definitions are not required, and any suitable scheme for organizing waveforms may be utilized, and various time divisions of the waveform may have any suitable duration.

In general, base stations 108 may include a backhaul interface for communication with a backhaul portion 120 of the wireless communication system. The backhaul 120 may provide a link between a base station 108 and the core network 102. Further, in some examples, a backhaul network may provide interconnection between the respective base stations 108. Various types of backhaul interfaces may be employed, such as a direct physical connection, a virtual network, or the like using any suitable transport network.

The core network 102 may be a part of the wireless communication system 100, and may be independent of the radio access technology used in the RAN 104. In some examples, the core network 102 may be configured according to 5G standards (e.g., 5GC). In other examples, the core network 102 may be configured according to a 4G evolved packet core (EPC), or any other suitable standard or configuration.

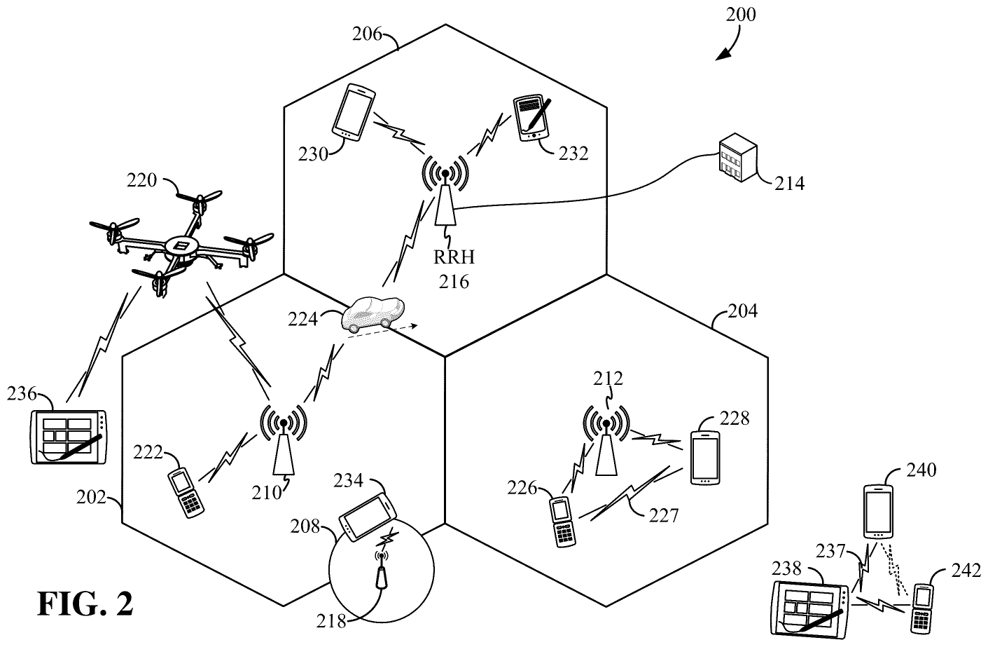

Referring now to FIG. 2, by way of example and without limitation, a schematic illustration of a RAN 200 is provided. In some examples, the RAN 200 may be the same as the RAN 104 described above and illustrated in FIG. 1. The geographic area covered by the RAN 200 may be divided into cellular regions (cells) that can be uniquely identified by a user equipment (UE) based on an identification broadcasted from one access point or base station. FIG. 2 illustrates macrocells 202, 204, and 206, and a small cell 208, each of which may include one or more sectors (not shown). A sector is a sub-area of a cell. All sectors within one cell are served by the same base station. A radio link within a sector can be identified by a single logical identification belonging to that sector. In a cell that is divided into sectors, the multiple sectors within a cell can be formed by groups of antennas with each antenna responsible for communication with UEs in a portion of the cell.

Various base station arrangements can be utilized. For example, in FIG. 2, two base stations 210 and 212 are shown in cells 202 and 204; and a third base station 214 is shown controlling a remote radio head (RRH) 216 in cell 206. That is, a base station can have an integrated antenna or can be connected to an antenna or RRH by feeder cables. In the illustrated example, the cells 202, 204, and 206 may be referred to as macrocells, as the base stations 210, 212, and 214 support cells having a large size. Further, a base station 218 is shown in the small cell 208 (e.g., a microcell, picocell, femtocell, home base station, home Node B, home eNode B, etc.) which may overlap with one or more macrocells. In this example, the cell 208 may be referred to as a small cell, as the base station 218 supports a cell having a relatively small size. Cell sizing can be done according to system design as well as component constraints.

It is to be understood that the radio access network 200 may include any number of wireless base stations and cells. Further, a relay node may be deployed to extend the size or coverage area of a given cell. The base stations 210, 212, 214, 218 provide wireless access points to a core network for any number of mobile apparatuses. In some examples, the base stations 210, 212, 214, and/or 218 may be the same as the base station/scheduling entity 108 described above and illustrated in FIG. 1.

Within the RAN 200, the cells may include UEs that may be in communication with one or more sectors of each cell. Further, each base station 210, 212, 214, and 218 may be configured to provide an access point to a core network (e.g., as illustrated in FIGS. 1 and/or 2) for all the UEs in the respective cells. For example, UEs 222 and 224 may be in communication with base station 210; UEs 226 and 228 may be in communication with base station 412; UEs 230 and 232 may be in communication with base station 214 by way of RRH 216; and UE 234 may be in communication with base station 218. In some examples, the UEs 222, 224, 226, 228, 230, 232, 234, 238, 240, and/or 242 may be the same as the UE/scheduled entity 106 described above and illustrated in FIG. 1.

In some examples, an unmanned aerial vehicle (UAV) 220, which may be a drone or quadcopter, can be a mobile network node and may be configured to function as a UE. For example, the UAV 220 may operate within cell 202 by communicating with base station 210.

Base stations 210, 212, 214, 218 may operate as scheduling entities, scheduling resources for communication among the UEs within their service areas or cells 202, 204, 206, 208, respectively. However, base stations are not the only entities that may function as a scheduling entity. That is, in some examples, a UE may function as a scheduling entity, scheduling resources for one or more scheduled entities (e.g., one or more other UEs). For example, two or more UEs (e.g., UEs 238, 240, and 242) may communicate with each other using peer to peer (P2P) or sidelink signals 237 without relaying that communication through a base station. In some examples, the UEs 238, 240, and 242 may each function as a scheduling entity or transmitting sidelink device and/or a scheduled entity or a receiving sidelink device to schedule resources and communicate sidelink signals 237 therebetween without relying on scheduling or control information from a base station. In other examples, two or more UEs (e.g., UEs 226 and 228) within the coverage area of a base station (e.g., base station 212) may also communicate sidelink signals 227 over a direct link (sidelink) without conveying that communication through the base station 246. In this example, the base station 212 may allocate resources to the UEs 226 and 228 for the sidelink communication. In either case, such sidelink signaling 227 and 237 may be implemented in a P2P network, a device-to-device (D2D) network, vehicle-to-vehicle (V2V) network, a vehicle-to-everything (V2X), a mesh network, or other suitable direct link network.

In the RAN 200, the ability for a UE to communicate while moving, independent of its location, is referred to as mobility. The various physical channels between the UE and the radio access network are generally set up, maintained, and released under the control of an AMF.

A RAN 200 may utilize DL-based mobility or UL-based mobility to enable mobility and handovers (e.g., the transfer of a UE's connection from one radio channel to another). In a network configured for DL-based mobility, during a call with a scheduling entity, or at any other time, a UE may monitor various parameters of the signal from its serving cell as well as various parameters of neighboring cells. Depending on the quality of these parameters, the UE may maintain communication with one or more of the neighboring cells. During this time, if the UE moves from one cell to another, or if signal quality from a neighboring cell exceeds that from the serving cell for a given amount of time, the UE may undertake a handoff or handover from the serving cell to the neighboring (target) cell. For example, UE 224 (illustrated as a vehicle, although any suitable form of UE may be used) may move from the geographic area corresponding to its serving cell 202 to the geographic area corresponding to a neighbor cell 206. When the signal strength or quality from the neighbor cell 206 exceeds that of its serving cell 202 for a given amount of time, the UE 224 may transmit a reporting message to its serving base station 210 indicating this condition. In response, the UE 224 may receive a handover command, and the UE may undergo a handover to the cell 206.

In a network configured for UL-based mobility, UL reference signals from each UE may be utilized by the network to select a serving cell for each UE. In some examples, the base stations 210, 212, and 214/216 may broadcast unified synchronization signals (e.g., unified Primary Synchronization Signals (PSSs), unified Secondary Synchronization Signals (SSSs) and unified Physical Broadcast Channels (PBCH)). The UEs 222, 224, 226, 228, 230, and 232 may receive the unified synchronization signals, derive the carrier frequency and slot timing from the synchronization signals, and in response to deriving timing, transmit an uplink pilot or reference signal. The uplink pilot signal transmitted by a UE (e.g., UE 224) may be concurrently received by two or more cells (e.g., base stations 210 and 214/216) within the radio access network 200. Each of the cells may measure a strength of the pilot signal, and the radio access network (e.g., one or more of the base stations 210 and 214/216 and/or a central node within the core network) may determine a serving cell for the UE 224. As the UE 224 moves through the radio access network 200, the network may continue to monitor the uplink pilot signal transmitted by the UE 224. When the signal strength or quality of the pilot signal measured by a neighboring cell exceeds that of the signal strength or quality measured by the serving cell, the network 200 may handover the UE 224 from the serving cell to the neighboring cell, with or without informing the UE 224.

Although the synchronization signal transmitted by the base stations 210, 212, and 214/216 may be unified, the synchronization signal may not identify a particular cell, but rather may identify a zone of multiple cells operating on the same frequency and/or with the same timing. The use of zones in 5G networks or other next generation communication networks enables the uplink-based mobility framework and improves the efficiency of both the UE and the network, since the number of mobility messages that need to be exchanged between the UE and the network may be reduced.

In various implementations, the air interface in the radio access network 200 may utilize licensed spectrum, unlicensed spectrum, or shared spectrum. Licensed spectrum provides for exclusive use of a portion of the spectrum, generally by virtue of a mobile network operator purchasing a license from a government regulatory body. Unlicensed spectrum provides for shared use of a portion of the spectrum without need for a government-granted license. While compliance with some technical rules is generally still required to access unlicensed spectrum, generally, any operator or device may gain access. Shared spectrum may fall between licensed and unlicensed spectrum, wherein technical rules or limitations may be required to access the spectrum, but the spectrum may still be shared by multiple operators and/or multiple RATs. For example, the holder of a license for a portion of licensed spectrum may provide licensed shared access (LSA) to share that spectrum with other parties, e.g., with suitable licensee-determined conditions to gain access.

The air interface in the radio access network 200 may utilize one or more multiplexing and multiple access algorithms to enable simultaneous communication of the various devices. For example, 5G NR specifications provide multiple access for UL transmissions from UEs 222 and 224 to base station 210, and for multiplexing for DL transmissions from base station 210 to one or more UEs 222 and 224, utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes, and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the base station 210 to UEs 222 and 224 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

The air interface in the radio access network 200 may further utilize one or more duplexing algorithms. Duplex refers to a point-to-point communication link where both endpoints can communicate with one another in both directions. Full-duplex means both endpoints can simultaneously communicate with one another. Half-duplex means only one endpoint can send information to the other at a time. Half-duplex emulation is frequently implemented for wireless links utilizing time division duplex (TDD). In TDD, transmissions in different directions on a given channel are separated from one another using time division multiplexing. That is, at some times the channel is dedicated for transmissions in one direction, while at other times the channel is dedicated for transmissions in the other direction, where the direction may change very rapidly, e.g., several times per slot. In a wireless link, a full-duplex channel generally relies on physical isolation of a transmitter and receiver, and suitable interference cancellation technologies. Full-duplex emulation is frequently implemented for wireless links by utilizing frequency division duplex (FDD) or spatial division duplex (SDD). In FDD, transmissions in different directions may operate at different carrier frequencies (e.g., within paired spectrum). In SDD, transmissions in different directions on a given channel are separated from one another using spatial division multiplexing (SDM). In other examples, full-duplex communication may be implemented within unpaired spectrum (e.g., within a single carrier bandwidth), where transmissions in different directions occur within different sub-bands of the carrier bandwidth. This type of full-duplex communication may be referred to herein as sub-band full duplex (SBFD), also known as flexible duplex.

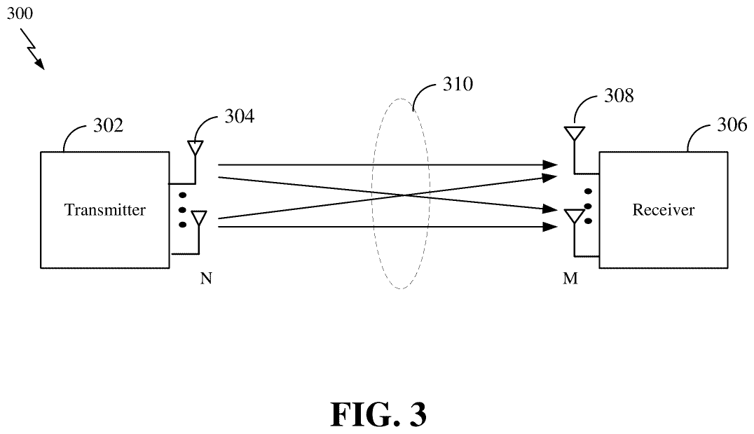

In some aspects of the disclosure, the scheduling entity and/or scheduled entity may be configured for beamforming and/or multiple-input multiple-output (MIMO) technology. FIG. 3 illustrates an example of a wireless communication system 300 supporting MIMO. In a MIMO system, a transmitter 302 includes multiple transmit antennas 304 (e.g., N transmit antennas) and a receiver 306 includes multiple receive antennas 308 (e.g., M receive antennas). Thus, there are N×M signal paths 310 from the transmit antennas 304 to the receive antennas 308. Each of the transmitter 302 and the receiver 306 may be implemented, for example, within a scheduling entity 108, a scheduled entity 106, or any other suitable wireless communication device.

The use of such multiple antenna technology enables the wireless communication system to exploit the spatial domain to support spatial multiplexing, beamforming, and transmit diversity. Spatial multiplexing may be used to transmit different streams of data, also referred to as layers, simultaneously on the same time-frequency resource. The data streams may be transmitted to a single UE to increase the data rate or to multiple UEs to increase the overall system capacity, the latter being referred to as multi-user MIMO (MU-MIMO). This is achieved by spatially precoding each data stream (e.g., multiplying the data streams with different weighting and phase shifting) and then transmitting each spatially precoded stream through multiple transmit antennas on the downlink. The spatially precoded data streams arrive at the UE(s) with different spatial signatures, which enables each of the UE(s) to recover the one or more data streams destined for that UE. On the uplink, each UE transmits a spatially precoded data stream, which enables the base station to identify the source of each spatially precoded data stream.

The number of data streams or layers corresponds to the rank of the transmission. In general, the rank of the MIMO system 300 is limited by the number of transmit or receive antennas 304 or 308, whichever is lower. In addition, the channel conditions at the UE, as well as other considerations, such as the available resources at the base station, may also affect the transmission rank. For example, the rank (and therefore, the number of data streams) assigned to a particular UE on the downlink may be determined based on the rank indicator (RI) transmitted from the UE to the base station. The RI may be determined based on the antenna configuration (e.g., the number of transmit and receive antennas) and a measured signal-to-interference-and-noise ratio (SINR) on each of the receive antennas. The RI may indicate, for example, the number of layers that may be supported under the current channel conditions. The base station may use the RI, along with resource information (e.g., the available resources and amount of data to be scheduled for the UE), to assign a transmission rank to the UE.

In Time Division Duplex (TDD) systems, the UL and DL are reciprocal, in that each uses different time slots of the same frequency bandwidth. Therefore, in TDD systems, the base station may assign the rank for DL MIMO transmissions based on UL SINR measurements (e.g., based on a Sounding Reference Signal (SRS) transmitted from the UE or other pilot signal). Based on the assigned rank, the base station may then transmit the CSI-RS with separate C-RS sequences for each layer to provide for multi-layer channel estimation. From the CSI-RS, the UE may measure the channel quality across layers and resource blocks and feedback the CQI and RI values to the base station for use in updating the rank and assigning REs for future downlink transmissions.

In the simplest case, as shown in FIG. 3, a rank-2 spatial multiplexing transmission on a 2×2 MIMO antenna configuration will transmit one data stream from each transmit antenna 304. Each data stream reaches each receive antenna 308 along a different signal path 310. The receiver 306 may then reconstruct the data streams using the received signals from each receive antenna 308.

Beamforming is a signal processing technique that may be used at the transmitter 302 or receiver 306 to shape or steer an antenna beam (e.g., a transmit beam or receive beam) along a spatial path between the transmitter 302 and the receiver 306. Beamforming may be achieved by combining the signals communicated via antennas 304 or 308 (e.g., antenna elements of an antenna array module) such that some of the signals experience constructive interference while others experience destructive interference. To create the desired constructive/destructive interference, the transmitter 302 or receiver 306 may apply amplitude and/or phase offsets to signals transmitted or received from each of the antennas 304 or 308 associated with the transmitter 302 or receiver 306. A beam may be formed by, but not limited to, an antenna, an antenna port, an antenna element, a group of antennas, a group of antenna ports or a group of antenna elements. The beam may be alternatively made with a certain reference signal resource. The beam may be equivalent to a spatial domain filtering by which an electromagnetic (EM) radiation is transmitted.

In 5G New Radio (NR) systems, particularly for mmWave systems, beamformed signals may be utilized for most downlink channels, including the physical downlink control channel (PDCCH) and physical downlink shared channel (PDSCH). In addition, broadcast information, such as the SSB, CSI-RS, slot format indicator (SFI), and paging information, may be transmitted in a beam-sweeping manner to enable all scheduled entities (UEs) in the coverage area of a transmission and reception point (TRP) (e.g., a gNB) to receive the broadcast information. In addition, for UEs configured with beamforming antenna arrays, beamformed signals may also be utilized for uplink channels, including the physical uplink control channel (PUCCH) and physical uplink shared channel (PUSCH).

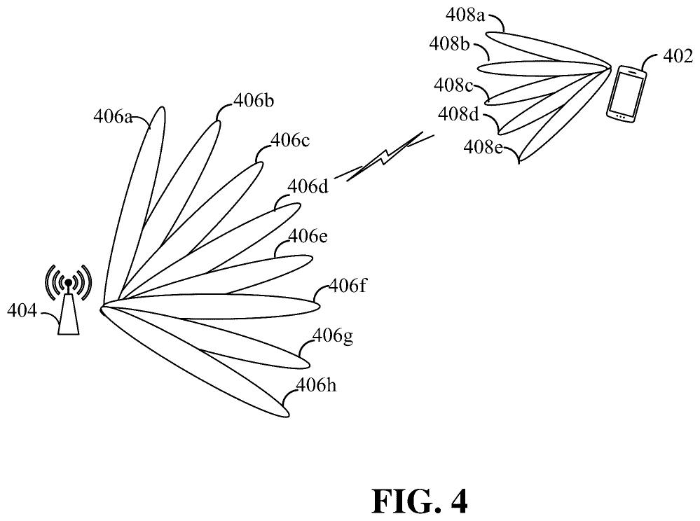

FIG. 4 is a diagram illustrating communication between a base station 404 and a UE 402 using beamformed signals according to some aspects. The base station 404 may be any of the base stations (e.g., gNBs) or scheduling entities illustrated in FIG. 1-3, and the UE 402 may be any of the UEs or scheduled entities illustrated in FIGS. 1-3.

The base station 404 may generally be capable of communicating with the UE 402 using one or more transmit beams, and the UE 402 may further be capable of communicating with the base station 404 using one or more receive beams. As used herein, the term transmit beam refers to a beam on the base station 404 that may be utilized for downlink or uplink communication with the UE 402. In addition, the term receive beam refers to a beam on the UE 402 that may be utilized for downlink or uplink communication with the base station 404.

In the example shown in FIG. 4, the base station 404 is configured to generate a plurality of transmit beams 406a, 406b, 406c, 406d, 406e, 406f, 406g, and 406h (406a-406h), each associated with a different spatial direction. In addition, the UE 402 is configured to generate a plurality of receive beams 408a, 408b, 408c, 408d, and 408e (408a-408e), each associated with a different spatial direction. It should be noted that while some beams are illustrated as adjacent to one another, such an arrangement may be different in different aspects. For example, transmit beams 406a-406h transmitted during a same symbol may not be adjacent to one another. In some examples, the base station 404 and UE 402 may each transmit more or less beams distributed in all directions (e.g., 360 degrees) and in three-dimensions. In addition, the transmit beams 406a-406h may include beams of varying beam width. For example, the base station 404 may transmit certain signals (e.g., synchronization signal blocks (SSBs)) on wider beams and other signals (e.g., CSI-RSs) on narrower beams.

The base station 404 and UE 402 may select one or more transmit beams 406a-406h on the base station 404 and one or more receive beams 408a-408e on the UE 402 for communication of uplink and downlink signals therebetween using a beam management procedure. In one example, during initial cell acquisition, the UE 402 may perform a P1 beam management procedure to scan the plurality of transmit beams 406a-406h on the plurality of receive beams 408a-408e to select a beam pair link (e.g., one of the transmit beams 406a-406h and one of the receive beams 408a-408e) for a physical random access channel (PRACH) procedure for initial access to the cell. For example, periodic SSB beam sweeping may be implemented on the base station 404 at certain intervals (e.g., based on the SSB periodicity). Thus, the base station 404 may be configured to sweep or transmit an SSB on each of a plurality of wider transmit beams 406a-406h during the beam sweeping interval. The UE may measure the reference signal received power (RSRP) of each of the SSB transmit beams on each of the receive beams of the UE and select the transmit and receive beams based on the measured RSRP. In an example, the selected receive beam may be the receive beam on which the highest RSRP is measured and the selected transmit beam may have the highest RSRP as measured on the selected receive beam.

After completing the PRACH procedure, the base station 404 and UE 402 may perform a P2 beam management procedure for beam refinement at the base station 404. For example, the base station 404 may be configured to sweep or transmit a CSI-RS on each of a plurality of narrower transmit beams 406a-406h. Each of the narrower CSI-RS beams may be a sub-beam of the selected SSB transmit beam (e.g., within the spatial direction of the SSB transmit beam). Transmission of the CSI-RS transmit beams may occur periodically (e.g., as configured via radio resource control (RRC) signaling by the gNB), semi-persistently (e.g., as configured via RRC signaling and activated/deactivated via medium access control—control element (MAC-CE) signaling by the gNB), or aperiodically (e.g., as triggered by the gNB via downlink control information (DCI)). The UE 402 is configured to scan the plurality of CSI-RS transmit beams 406a-406h on the plurality of receive beams 408a-408e. The UE 402 then performs beam measurements (e.g., RSRP, SINR, etc.) of the received CSI-RSs on each of the receive beams 408a-408e to determine the respective beam quality of each of the CSI-RS transmit beams 406a-406h as measured on each of the receive beams 408a-408e.

The UE 402 can then generate and transmit a Layer 1 (L1) measurement report, including the respective beam index (e.g., CSI-RS resource indicator (CRI)) and beam measurement (e.g., RSRP or SINR) of one or more of the CSI-RS transmit beams 406a-406h on one or more of the receive beams 408a-408e to the base station 404. The base station 404 may then select one or more CSI-RS transmit beams on which to communicate downlink and/or uplink control and/or data with the UE 402. In some examples, the selected CSI-RS transmit beam(s) have the highest RSRP from the L1 measurement report. Transmission of the L1 measurement report may occur periodically (e.g., as configured via RRC signaling by the gNB), semi-persistently (e.g., as configured via RRC signaling and activated/deactivated via MAC-CE signaling by the gNB), or aperiodically (e.g., as triggered by the gNB via DCI).

The UE 402 may further select a corresponding receive beam on the UE 402 for each selected serving CSI-RS transmit beam to form a respective beam pair link (BPL) for each selected serving CSI-RS transmit beam. For example, the UE 402 can utilize the beam measurements obtained during the P2 procedure or perform a P3 beam management procedure to obtain new beam measurements for the selected CSI-RS transmit beams to select the corresponding receive beam for each selected transmit beam. In some examples, the selected receive beam to pair with a particular CSI-RS transmit beam may be the receive beam on which the highest RSRP for the particular CSI-RS transmit beam is measured.

In some examples, in addition to performing CSI-RS beam measurements, the base station 404 may configure the UE 402 to perform SSB beam measurements and provide an L1 measurement report containing beam measurements of SSB transmit beams 406a-406h. For example, the base station 404 may configure the UE 402 to perform SSB beam measurements and/or CSI-RS beam measurements for beam failure detection (BRD), beam failure recovery (BFR), cell reselection, beam tracking (e.g., for a mobile UE 402 and/or base station 404), or other beam optimization purpose.

In addition, when the channel is reciprocal, the transmit and receive beams may be selected using an uplink beam management scheme. In an example, the UE 402 may be configured to sweep or transmit on each of a plurality of receive beams 408a-408e. For example, the UE 402 may transmit an SRS on each beam in the different beam directions. In addition, the base station 404 may be configured to receive the uplink beam reference signals on a plurality of transmit beams 406a-406h. The base station 404 then performs beam measurements (e.g., RSRP, SINR, etc.) of the beam reference signals on each of the transmit beams 406a-406h to determine the respective beam quality of each of the receive beams 408a-408e as measured on each of the transmit beams 406a-406h.

The base station 404 may then select one or more transmit beams on which to communicate downlink and/or uplink control and/or data with the UE 402. In some examples, the selected transmit beam(s) have the highest RSRP. The UE 402 may then select a corresponding receive beam for each selected serving transmit beam to form a respective beam pair link (BPL) for each selected serving transmit beam, using, for example, a P3 beam management procedure, as described above.

In one example, a single CSI-RS transmit beam (e.g., beam 406d) on the base station 404 and a single receive beam (e.g., beam 408c) on the UE may form a single BPL used for communication between the base station 404 and the UE 402. In another example, multiple CSI-RS transmit beams (e.g., beams 406c, 406d, and 406e) on the base station 404 and a single receive beam (e.g., beam 408c) on the UE 402 may form respective BPLs used for communication between the base station 404 and the UE 402. In another example, multiple CSI-RS transmit beams (e.g., beams 406c, 406d, and 406e) on the base station 404 and multiple receive beams (e.g., beams 408c and 408d) on the UE 402 may form multiple BPLs used for communication between the base station 404 and the UE 402. In this example, a first BPL may include transmit beam 406c and receive beam 408c, a second BPL may include transmit beam 408d and receive beam 408c, and a third BPL may include transmit beam 408e and receive beam 408d.

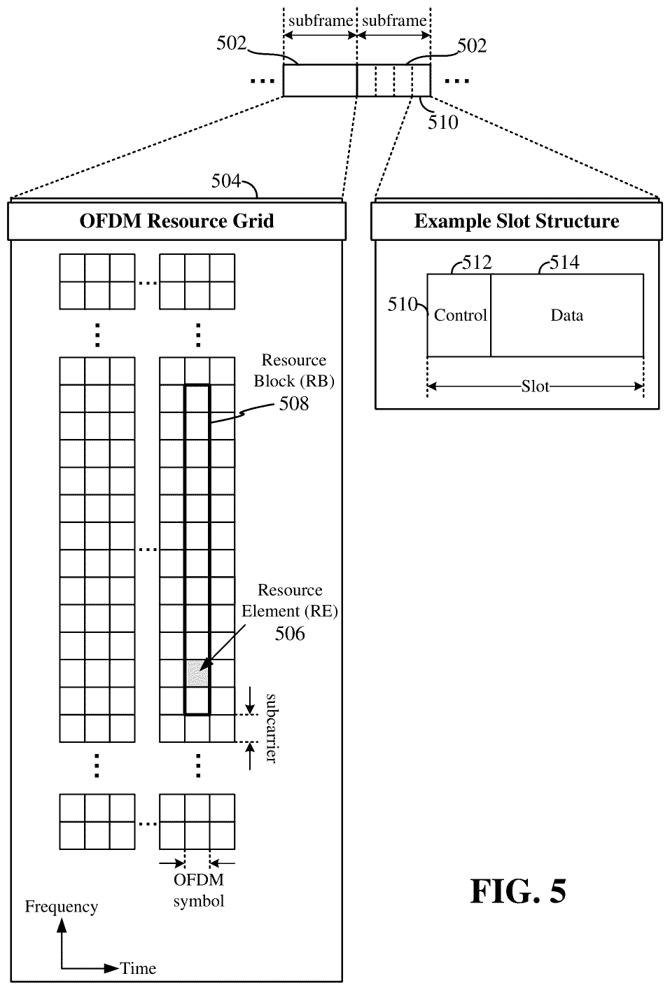

Various aspects of the present disclosure will be described with reference to an OFDM waveform, schematically illustrated in FIG. 5. It should be understood by those of ordinary skill in the art that the various aspects of the present disclosure may be applied to an SC-FDMA waveform in substantially the same way as described herein below. That is, while some examples of the present disclosure may focus on an OFDM link for clarity, it should be understood that the same principles may be applied as well to SC-FDMA waveforms.

Referring now to FIG. 5, an expanded view of an exemplary DL subframe 502 is illustrated, showing an OFDM resource grid. However, as those skilled in the art will readily appreciate, the PHY transmission structure for any particular application may vary from the example described here, depending on any number of factors. Here, time is in the horizontal direction with units of OFDM symbols; and frequency is in the vertical direction with units of subcarriers.

The resource grid 504 may be used to schematically represent time-frequency resources for a given antenna port. That is, in a multiple-input-multiple-output (MIMO) implementation with multiple antenna ports available, a corresponding multiple number of resource grids 504 may be available for communication. The resource grid 504 is divided into multiple resource elements (REs) 506. An RE, which is 1 subcarrier×1 symbol, is the smallest discrete part of the time-frequency grid, and contains a single complex value representing data from a physical channel or signal. Depending on the modulation utilized in a particular implementation, each RE may represent one or more bits of information. In some examples, a block of REs may be referred to as a physical resource block (PRB) or a resource block (RB) 508, which contains any suitable number of consecutive subcarriers in the frequency domain. In one example, an RB may include 12 subcarriers, a number independent of the numerology used. In some examples, depending on the numerology, an RB may include any suitable number of consecutive OFDM symbols in the time domain. Within the present disclosure, it is assumed that a single RB such as the RB 508 entirely corresponds to a single direction of communication (either transmission or reception for a given device).

Scheduling of UEs (e.g., scheduled entities) for downlink or uplink transmissions typically involves scheduling one or more resource elements 506 within one or more sub-bands. Thus, a UE generally utilizes only a subset of the resource grid 504. In some examples, an RB may be the smallest unit of resources that can be allocated to a UE. Thus, the more RBs scheduled for a UE, and the higher the modulation scheme chosen for the air interface, the higher the data rate for the UE.

In this illustration, the RB 508 is shown as occupying less than the entire bandwidth of the subframe 502, with some subcarriers illustrated above and below the RB 508. In a given implementation, the subframe 502 may have a bandwidth corresponding to any number of one or more RBs 508. Further, in this illustration, the RB 508 is shown as occupying less than the entire duration of the subframe 502, although this is merely one possible example.

Each 1 ms subframe 502 may consist of one or multiple adjacent slots. In the example shown in FIG. 5, one subframe 502 includes four slots 510, as an illustrative example. In some examples, a slot may be defined according to a specified number of OFDM symbols with a given cyclic prefix (CP) length. For example, a slot may include 7 or 14 OFDM symbols with a nominal CP. Additional examples may include mini-slots, sometimes referred to as shortened transmission time intervals (TTIs), having a shorter duration (e.g., one to three OFDM symbols). These mini-slots or shortened transmission time intervals (TTIs) may in some cases be transmitted occupying resources scheduled for ongoing slot transmissions for the same or for different UEs. Any number of resource blocks may be utilized within a subframe or slot.

An expanded view of one of the slots 510 illustrates the slot 510 including a control region 512 and a data region 514. In general, the control region 512 may carry control channels, and the data region 514 may carry data channels. Of course, a slot may contain all DL, all UL, or at least one DL portion and at least one UL portion. The structure illustrated in FIG. 5 is merely exemplary in nature, and different slot structures may be utilized, and may include one or more of each of the control region(s) and data region(s).

Although not illustrated in FIG. 5, the various REs 506 within a RB 508 may be scheduled to carry one or more physical channels, including control channels, shared channels, data channels, etc. Other REs 506 within the RB 508 may also carry pilots or reference signals. These pilots or reference signals may provide for a receiving device to perform channel estimation of the corresponding channel, which may enable coherent demodulation/detection of the control and/or data channels within the RB 508.

In some examples, the slot 510 may be utilized for broadcast or unicast communication. For example, a broadcast, multicast, or groupcast communication may refer to a point-to-multipoint transmission by one device (e.g., a base station, UE, or other similar device) to other devices. Here, a broadcast communication is delivered to all devices, whereas a multicast communication is delivered to multiple intended recipient devices. A unicast communication may refer to a point-to-point transmission by a one device to a single other device.

In an example of cellular communication over a cellular carrier via a Uu interface, for a DL transmission, the scheduling entity (e.g., a base station) may allocate one or more REs 506 (e.g., within the control region 512) to carry DL control information including one or more DL control channels, such as a physical downlink control channel (PDCCH), to one or more scheduled entities (e.g., UEs). The PDCCH carries downlink control information (DCI) including but not limited to power control commands (e.g., one or more open loop power control parameters and/or one or more closed loop power control parameters), scheduling information, a grant, and/or an assignment of REs for DL and UL transmissions. The PDCCH may further carry HARQ feedback transmissions such as an acknowledgment (ACK) or negative acknowledgment (NACK). HARQ is a technique well-known to those of ordinary skill in the art, wherein the integrity of packet transmissions may be checked at the receiving side for accuracy, e.g., utilizing any suitable integrity checking mechanism, such as a checksum or a cyclic redundancy check (CRC). If the integrity of the transmission is confirmed, an ACK may be transmitted, whereas if not confirmed, a NACK may be transmitted. In response to a NACK, the transmitting device may send a HARQ retransmission, which may implement chase combining, incremental redundancy, etc.

The base station may further allocate one or more REs 506 (e.g., in the control region 512 or the data region 514) to carry other DL signals, such as a demodulation reference signal (DMRS); a phase-tracking reference signal (PT-RS); a channel state information (CSI) reference signal (CSI-RS); and a synchronization signal block (SSB). SSBs may be broadcast at regular intervals based on a periodicity (e.g., 5, 10, 20, 40, 80, or 140 ms). An SSB includes a primary synchronization signal (PSS), a secondary synchronization signal (SSS), and a physical broadcast control channel (PBCH). A UE may utilize the PSS and SSS to achieve radio frame, subframe, slot, and symbol synchronization in the time domain, identify the center of the channel (system) bandwidth in the frequency domain, and identify the physical cell identity (PCI) of the cell.

The PBCH in the SSB may further include a master information block (MIB) that includes various system information, along with parameters for decoding a system information block (SIB). The SIB may be, for example, a SystemInformationType 1 (SIB1) that may include various additional system information. Examples of system information transmitted in the MIB may include, but are not limited to, a subcarrier spacing, system frame number, a configuration of a PDCCH control resource set (CORESET) (e.g., PDCCH CORESET0), and a search space for SIB1. Examples of additional system information transmitted in the SIB1 may include, but are not limited to, a random access search space, downlink configuration information, and uplink configuration information. The MIB and SIB1 together provide the minimum system information (SI) for initial access.

In an UL transmission, the scheduled entity (e.g., UE) may utilize one or more REs 506 to carry UL control information (UCI) including one or more UL control channels, such as a physical uplink control channel (PUCCH), to the scheduling entity. UCI may include a variety of packet types and categories, including pilots, reference signals, and information configured to enable or assist in decoding uplink data transmissions. Examples of uplink reference signals may include a sounding reference signal (SRS) and an uplink DMRS. In some examples, the UCI may include a scheduling request (SR), e.g., request for the scheduling entity to schedule uplink transmissions. Here, in response to the SR transmitted on the UCI, the scheduling entity may transmit downlink control information (DCI) that may schedule resources for uplink packet transmissions. UCI may also include HARQ feedback, channel state feedback (CSF), such as a CSI report, or any other suitable UCI.

In addition to control information, one or more REs 506 (e.g., within the data region 514) may be allocated for data traffic. Such data traffic may be carried on one or more traffic channels, such as, for a DL transmission, a physical downlink shared channel (PDSCH); or for an UL transmission, a physical uplink shared channel (PUSCH). In some examples, one or more REs 506 within the data region 514 may be configured to carry other signals, such as one or more SIBs and DMRSs.

In an example of sidelink communication over a sidelink carrier via a proximity service (ProSe) PC5 interface, the control region 512 of the slot 510 may include a physical sidelink control channel (PSCCH) including sidelink control information (SCI) transmitted by an initiating (transmitting) sidelink device (e.g., V2X or other sidelink device) towards a set of one or more other receiving sidelink devices. The data region 514 of the slot 510 may include a physical sidelink shared channel (PSSCH) including sidelink data traffic transmitted by the initiating (transmitting) sidelink device within resources reserved over the sidelink carrier by the transmitting sidelink device via the SCI. Other information may further be transmitted over various REs 506 within slot 510. For example, HARQ feedback information may be transmitted in a physical sidelink feedback channel (PSFCH) within the slot 510 from the receiving sidelink device to the transmitting sidelink device. In addition, one or more reference signals, such as a sidelink SSB and/or a sidelink CSI-RS, may be transmitted within the slot 510.

These physical channels described above are generally multiplexed and mapped to transport channels for handling at the medium access control (MAC) layer. Transport channels carry blocks of information called transport blocks (TB). The transport block size (TBS), which may correspond to a number of bits of information, may be a controlled parameter, based on the modulation and coding scheme (MCS) and the number of RBs in a given transmission.

The channels or carriers described herein are not necessarily all of the channels or carriers that may be utilized between a scheduling entity and scheduled entities, and those of ordinary skill in the art will recognize that other channels or carriers may be utilized in addition to those illustrated, such as other traffic, control, and feedback channels.

In OFDM, to maintain orthogonality of the subcarriers or tones, the subcarrier spacing may be equal to the inverse of the symbol period. A numerology of an OFDM waveform refers to its particular subcarrier spacing and cyclic prefix (CP) overhead. A scalable numerology refers to the capability of the network to select different subcarrier spacings, and accordingly, with each spacing, to select the corresponding symbol duration, including the CP length. With a scalable numerology, a nominal subcarrier spacing (SCS) may be scaled upward or downward by integer multiples. In this manner, regardless of CP overhead and the selected SCS, symbol boundaries may be aligned at certain common multiples of symbols (e.g., aligned at the boundaries of each 1 ms subframe). The range of SCS may include any suitable SCS. For example, a scalable numerology may support a SCS ranging from 15 kHz to 480 kHz.

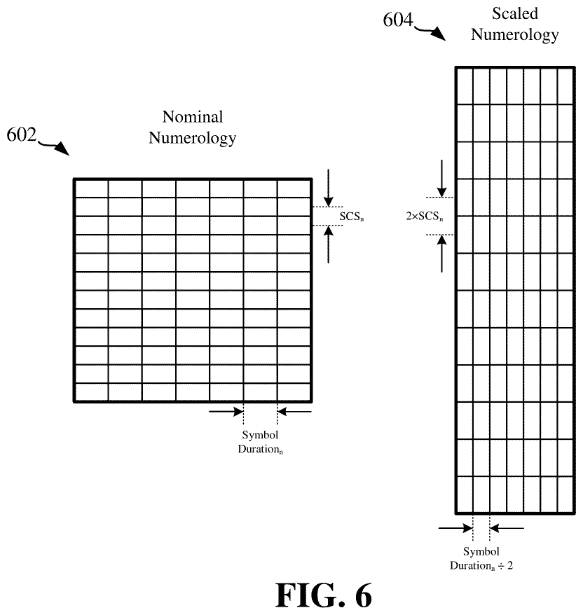

To illustrate this concept of a scalable numerology, FIG. 6 shows a first RB 602 having a nominal numerology, and a second RB 604 having a scaled numerology. As one example, the first RB 602 may have a ‘nominal’ subcarrier spacing (SCSₙ) of 30 kHz, and a ‘nominal’ symbol durationₙ of 333 μs. Here, in the second RB 604, the scaled numerology includes a scaled SCS of double the nominal SCS, or 2×SCSₙ=60 kHz. Because this provides twice the bandwidth per symbol, it results in a shortened symbol duration to carry the same information. Thus, in the second RB 604, the scaled numerology includes a scaled symbol duration of half the nominal symbol duration, or (symbol durationₙ)÷2=167 s.

In some aspects, CLI may occur when a network configures different TDD UL transmission and DL transmission slot formats to nearby user equipment (UEs). When an aggressor UE is transmitting an UL transmission, a victim UE may receive the UL transmission as CLI in the DL symbols if the aggressor UE's UL symbol collides with at least one DL symbol of the victim UE. In some aspects, CLI may occur between two or more UEs on the same cell or on different cells. In Release-16 New Radio (NR), the signaling procedure for a victim UE may be to measure CLI from an aggressor UE. The aggressor UE may not transmit a slot that is dedicated for CLI measurement by a victim UE and may not be aware that its UL transmission is measured by the victim UE. The network may configure one or more CLI measurement resources for the victim UE to measure the CLI of the UL transmission from the aggressor UE. After recording (e.g., measuring) one or more CLI measurements using the one or more CLI measurement resources of the UL transmission from the aggressor UE, the victim UE may transmit a CLI measurement report containing the one or more CLI measurements to the network so that the network may manage the scheduling of the aggressor UE and the victim UE to balance the throughput of both the aggressor UE and the victim UE.

In some aspects, a victim UE may not need to receive concurrent serving cell DL signals/channels (such as serving cell physical downlink control channel (PDCCH), physical downlink shared channel (PDSCH), and channel state information (CSI) reference signal (CSI-RS) for channel state feedback (CSF) and beam management) together with CLI measurement resource in the same symbol. If a configured CLI measurement resource collides with serving cell DL signals/channels in time domain, the victim UE should receive the CLI measurement resource and skip the serving cell DL signals/channels. For example, the CLI measurement resource by nature may have a different timing from the serving cell DL signals/channels. Separate fast Fourier transform (FFT) window timings may be required to receive both the CLI measurement resource and serving cell DL signals/channels. Supporting two FFT windows in a same symbol may not be preferrable to UE implementation. In some aspects, prioritizing a CLI resource by higher layer configuration over dynamically scheduled DL channels/signals as well as prioritizing PDCCH over CLI measurement may be a simpler (e.g., semi-static) operation. It should be noted that besides timing, frequency and power may be very different between serving cell DL signals/channels and CLI measurement resource. Relative speed vector between a victim UE and an aggressor UE may be different from relative speed vector between a victim UE and base station. DL signal power may be different from the UL transmission power of an aggressor UE. However, currently, the victim UE may use its DL tracking loops to receive CLI.

In some aspects, a victim UE may receive CLI measurement resources from different sources concurrently. For example, a victim UE may receive an UL transmission from two or more different aggressor UEs within a same cell or within different cells. A victim UE may measure every CLI measurement resource even if CLI measurement resource from different sources are configured in a same symbol. In some aspects, because all CLI measurement resources may be received using a victim UE's tracking loops for serving cell DL signals/channels, a victim UE may not be able to concurrently receive multiple CLI measurement resources. Instead, CLI measurement resources may be indistinguishable from the perspective of the victim UE's receiver tracking loop potentially creating sub-optimal measurement accuracy of the CLI measurement.

In some aspects, to improve CLI measurement accuracy, dedicated tracking loops (e.g., an automatic gain control (AGC) tracking loop, a time tracking loop (TTL), a frequency tracking loop (FTL)) may be used to measure CLI measurement resources. Using dedicated tracking loops, a victim UE may be able to distinguish between different CLI measurement resource based on differences in power, timing, frequency, and the like. In some aspects, a network may indicate to a victim UE that certain properties of a CLI measurement resource are sufficiently different so that the victim UE may use different tracking loops to receive these CLI measurement resources.

For example, a scheduling entity may transmit an indication to a first UE (e.g., a victim UE) that a plurality of CLI measurement resources is within a same CLI measurement resource group of one or more CLI measurement resource groups. The first UE may determine that the plurality of CLI measurement resources is within the same CLI measurement resource group of the one or more CLI measurement resource groups. The scheduling entity may transmit a DL transmission to the first UE when the first UE receives at least two CLI measurement resources of the plurality of CLI measurement resources in one or more same symbols of at least two concurrent uplink (UL) transmissions using at least one dedicated tracking loop. The first UE may determine one or more CLI measurements for the at least two CLI measurement resources based on the at least two CLI measurement resources being received in the one or more same symbols of the at least two concurrent UL transmissions and being within the same CLI measurement resource group of the one or more CLI measurement resource groups. The first UE may transmit to the scheduling entity a CLI measurement report including the one or more CLI measurements for the at least two CLI measurement resources.

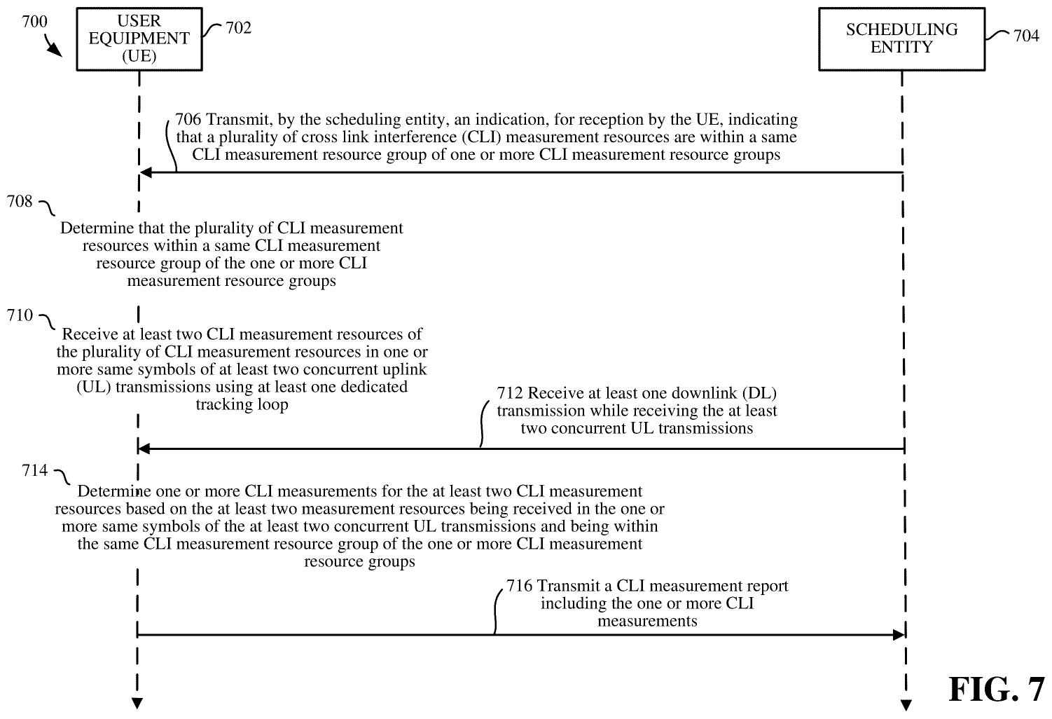

FIG. 7 is a conceptual diagram illustrating an example environment 700 for concurrent measurement of multiple CLI measurement resources according to some aspects. In the example shown in FIG. 7, a user equipment (UE) 702 (e.g., a victim UE) is in wireless communication with a scheduling entity 704 over one or more wireless communication links. Each of the UE 702 and the scheduling entity 704 may correspond to any of the entities, gNodeBs, UEs, or the like as shown in FIGS. 1-4.

At 706, the scheduling entity 704 may transmit to the UE 702 an indication indicating that a plurality of CLI measurement resources is within a same CLI measurement resource group of one or more CLI measurement resource groups. In some aspects, the indication may indicate that the UE 702 is to receive each of the plurality of CLI measurement resources in the CLI measurement resource group in one or more UL transmissions using a same tracking loop. The same tracking loop may be at least one of an AGC tracking loop, a TTL, a FTL, or the like. A tracking loop may include a timing associated with one or more antenna ports and used for synchronization with one or more resources of a received signal.

In some aspects, the indication may also define a CLI measurement resource group including one or more specific CLI measurement resources where each of the one or more specific CLI measurement resources have at least one common parameter. In at least this case, the UE 702 may be unable to determine which common parameter(s) are shared with each CLI measurement resource within the CLI measurement resource group, but may determine that each specific CLI measurement resource within the CLI measurement group shares at least one common parameter.

In some aspects, the indication may define an association relationship of the one or more CLI measurement resources within the CLI measurement resource group. For example, the indication may identify at least one common parameter among each CLI measurement resource within the CLI measurement group. Upon receiving the indication of the at least one common parameter, the UE 702 may determine which CLI measurement resources of a plurality of CLI measurement resources are within the CLI measurement group based on determining which CLI measurement resources have the common parameter.

In some aspects, the at least one common parameter may include at least one of a specified geographic relationship with the UE, a specified power, a specified power range, a power that is below a high threshold power, a power that is above a low threshold power, a specified frequency, a specified frequency range, a frequency that is below a high threshold frequency, a frequency that is above a low threshold frequency, a specified timing, a specified timing range, a timing that is below a high threshold timing offset, a timing that is above a low threshold timing offset, or the like.

In some aspects, the UE 702 may have at least two tracking loops used to receive at least two CLI measurement resources in a same OFDM symbol. For example, before receiving CLI measurement resources, the UE 702 may transmit a message to the scheduling entity 704 identifying that the UE 702 is configured to concurrently receive at least two CLI measurement resources. The UE 702 may also indicate a maximum quantity of CLI measurement resources that the UE 702 is configured to concurrently receive in a same symbol or across symbols. For example, the message may contain a number one (1), a number two (2), a number three (3), or more, where the number one (1) indicates that the UE 702 is not configured to currently receive at least two CLI measurement resources, the number two (2) indicates that the UE 702 is configured to currently receive two CLI measurement resources, the number three (3) indicates that the UE 702 is configured to currently receive three CLI measurement resources, and so on. The maximum quantity of CLI measurement resources may be determined by the quantity of tracking loops of the UE 702. In some aspects, each of the at least two tracking loops may be used to receive a different CLI measurement resource group including one or more CLI measurement resources.

In some aspects, when the UE 702 is configured to receive concurrent CLI measurement resources with different tracking loops, the number of separate CLI measurement resource that use different tracking loops or the number of CLI measurement resource groups that use different tracking loops may exceed a maximum quantity of tracking loops of the UE 702, and thus a maximum capability of the UE 702. The UE 702 and/or the scheduling entity 704 may assign different priority values to each CLI measurement resource and/or each CLI measurement resource group utilizing different tracking loops. For example, based on a priority value, the UE 702 may determine to receive a CLI measurement resource and/or a CLI measurement resource group having a first priority value and skip a CLI measurement resource and/or a CLI measurement resource group having a second priority value when the first priority value is greater than the second priority value. In some aspects, different priority values may be assigned to different properties (e.g., timing, frequency, power, or the like). The UE 702 may also determine which CLI measurement resources with certain common properties have higher priority values compared to others. In some aspects, when the scheduling entity 704 assigns different priority values to each CLI measurement resource utilizing different tracking loops and/or each CLI measurement resource group utilizing different tracking loops, the scheduling entity 704 may include the assigned priority values in the indication.

As described herein, the scheduling entity 704 may include a priority value for each CLI measurement resource and/or each CLI measurement group. Also as described herein, each of the CLI measurement resources may be included in one or more UL transmissions from one or more sources (e.g., one or more aggressor UEs). In some aspects, the scheduling entity 704 may determine a geographic relationship between the UE 702 and one or more other aggressor UEs. For example, based on the geographic relationship between the UE 702 and one or more aggressor UEs, the scheduling entity 704 may assign a highest priority value to UL transmissions from a closest aggressor UE that is closest to the UE 702 compared to one or more remaining aggressor UEs. The scheduling entity 704 may assign a second highest priority value to UL transmissions from another aggressor UE that is further from the UE 702 than the closest aggressor UE but closer to the UE 702 compared to the one or more remaining aggressor UEs. Accordingly, the scheduling entity 704 may assign a lowest priority value to UL transmissions from a furthest aggressor UE that is further from the UE 702 compared to the other one or more aggressor UEs. In some aspects, when the scheduling entity 704 assigns different priority values to each CLI measurement resource and/or each CLI measurement resource group based on geographic relationships between the UE 702 and one or more aggressor UEs, the scheduling entity 704 may include the assigned priority values in the indication.

In some aspects, the scheduling entity 704 may determine a transmission power value for UL transmissions from each aggressor UE of one or more aggressor UEs (e.g., based on an aggressor UE power class). Based on the transmission power values for UL transmissions from each aggressor UE of one or more aggressor UEs, the scheduling entity 704 may assign a highest priority value to an aggressor UE with the highest transmission power value among the one or more aggressor UEs. The scheduling entity 704 may assign a second highest priority value to another aggressor UE with the second highest transmission power value among the one or more aggressor UEs. Accordingly, the scheduling entity 704 may assign a lowest priority value to an aggressor UE that is lowest transmission power value among the one or more aggressor UEs. In some aspects, when the scheduling entity 704 assigns different priority values to each CLI measurement resource and/or each CLI measurement resource group based on the transmission power values for UL transmissions from each aggressor UE of one or more aggressor UEs, the scheduling entity 704 may include the assigned priority values in the indication.

In some aspects, the UE 702 may be configured to autonomously group different CLI measurement resources according to at least one common parameter, described herein, and assign priority values to the different groups. For example, the UE 702 may autonomously determine a priority value of each CLI measurement resource, as similarly described with respect to the scheduling entity 704, and group the CLI measurement resources into one or more CLI measurement resource groups based on the determined priority values. In some aspects, the UE 702 may transmit a message to the scheduling entity 704 indicating that the UE 702 is configured to autonomously group different CLI measurement resources according to at least one common parameter and assign priority values to the different groups so that the scheduling entity 704 does not have to do so. For example, the UE 702 may consider a CLI measurement resource with higher transmission power to have a higher priority value compared to a CLI measurement resource with lower transmission power. The UE 702 may consider a CLI measurement resource with a smaller frequency offset relative to its own serving DL signal to have a higher priority value compared to a CLI measurement resource with a greater frequency offset relative to its own serving DL signal. The UE 702 may consider a CLI measurement resource with a smaller timing offset relative to its own serving UL signal to have a higher priority value compared to a CLI measurement resource with a greater timing offset relative to its own serving UL signal. In such cases, the UE 702 may want to prioritize a CLI measurement resource from a higher power or closer aggressor. Similarly, the UE 702 may put CLI measurement resources with a similar power, timing, or frequency property into the same CLI measurement resource group.

In some aspects, for the UE 702 to autonomously group CLI measurement resources, the scheduling entity 704 may transmit range values and/or threshold value for each property (power, timing, frequency, and the like) of the CLI measurement resource. These range values and/or threshold values may be included in the indication from the scheduling entity 704 to the UE 702.

At 708, the UE 702 may determine that the plurality of CLI measurement resources is within the same CLI measurement resource group of the one or more CLI measurement resource groups. For example, the UE 702 may receive the indication from the scheduling entity 704 indicating that the plurality of CLI measurement resources is within the same CLI measurement resource group of the one or more CLI measurement resource groups. Based on the received indication from the scheduling entity 704, the UE 702 may determine that the plurality of CLI measurement resources is within the same CLI measurement resource group of the one or more CLI measurement resource groups. As another example, the UE 702 may autonomously determine that the plurality of CLI measurement resources is within the same CLI measurement resource group of the one or more CLI measurement resource groups. The UE 702 may receive an indication from the scheduling entity 704, as described herein, indicating that the plurality of CLI measurement resources is within the same CLI measurement resource group of the one or more CLI measurement resource groups. In response, the UE 702 may ignore the indication and autonomously determine that the plurality of CLI measurement resources is within the same CLI measurement resource group of the one or more CLI measurement resource groups. Additionally, or alternatively, in response, the UE 702 may transmit a message to the scheduling entity 704, as described herein, indicating that the UE 702 is configured to autonomously group different CLI measurement resources according to at least one common parameter and assign priority values to the different CLI measurement resource groups so that the scheduling entity 704 does not have to do so. In some aspects, the UE 702 may not receive the indication from the scheduling entity 704 and autonomously determine that the plurality of CLI measurement resources is within the same CLI measurement resource group of the one or more CLI measurement resource groups. Additionally, or alternatively, the UE 702 may not receive the indication from the scheduling entity 704, but may autonomously transmit a message to the scheduling entity 704, as described herein, indicating that the UE 702 is configured to autonomously group different CLI measurement resources according to at least one common parameter and assign priority values to the different CLI measurement resource groups so that the scheduling entity 704 does not have to do so.

At 710, the UE 702 may receive at least two CLI measurement resources of the plurality of CLI measurement resources in one or more same symbols of at least two concurrent uplink (UL) transmissions using at least one dedicated tracking loop and, at 712, the UE 702 may receive at least one downlink (DL) transmission while receiving the at least two concurrent UL transmissions. For example, the UE 702 may receive a first UL transmission from a first aggressor UE including one or more first CLI measurement resources. The UE 702 may also receive a second UL transmission from a second aggressor UE including one or more second CLI measurement resources at a same or similar time with the first UL transmission so that at least one CLI measurement resource of the first UL transmission overlaps with at least one CLI measurement resource of the second UL transmission. Thus, the first CLI measurement resources and the second CLI measurement resources may have one or more overlapping resources (e.g., slots) having a same symbol. At the same time, the UE 702 may receive a DL transmission from the scheduling entity 704. The first UL transmission and the second UL transmission may create cross link interference (CLI) with the DL transmission from the scheduling entity 704. In some aspects, at least one of the first UL transmission from the first aggressor UE or the second UL transmission from the second aggressor UE may be for reception by the scheduling entity 706. Additionally, or alternatively, at least one of the first UL transmission from the first aggressor UE or the second UL transmission from the second aggressor UE may be for reception by one or more other scheduling entities other than the scheduling entity 704.

Based on the UE 702 determining that at least one of the first CLI measurement resources or the second CLI measurement resources are within the same CLI measurement resource group of the one or more CLI measurement resource groups, the UE 702 may use the indication to determine one or more CLI measurements. For example, the scheduling entity 704 and/or a network associated with the scheduling entity 704 may indicate in the indication that the one or more first CLI measurement resources and the one or more second CLI measurement resources are to be received using a same dedicated tracking loop of the UE 702. Because the one or more first CLI measurement resources and the one or more second CLI measurement resources are in the same CLI measurement group, the one or more first CLI measurement resources and the one or more second CLI measurement resources may share one or more same or similar parameters such as a power, a frequency offset, a timing offset, a first proximity of a source of the UL transmission including the one or more first CLI measurement resources, or the like. Thus, the UE 702 may select either the one or more first CLI measurement resources or the one or more second CLI measurement resources for determining (e.g., measuring) one or more CLI measurements while abstaining using the other to determine one or more CLI measurements.

In some aspects, the UE 702 may randomly select either the first one or more CLI measurement resources for determining one or more CLI measurements or the second one or more CLI measurement resources for determining one or more CLI measurements. In some aspects, the UE 702 may use one or more priority values associated with the first one or more CLI measurement resources and one or more priority values associated with the second one or more CLI measurement resources. The one or more first priority values may be assigned to the one or more first CLI measurement resources based on one or more parameters such as a power, a frequency offset, a timing offset, a first proximity of a source of the UL transmission including the one or more first CLI measurement resources, or the like. The one or more second priority values may be assigned to the one or more second CLI measurement resources based on one or more parameters such as a power, a frequency offset, a timing offset, a second proximity of a source of the UL transmission including the one or more second CLI measurement resources, or the like.

The UE 702 may select the one or more first CLI measurement resources for determining the one or more CLI measurements or the one or more second CLI measurement resources for determining the one or more CLI measurements based on a comparison between the one or more first priority values or the one or more second priority values. For example, when the UL transmission having the one or more first CLI measurement resources has a higher transmission power than the UL transmission having the one or more second CLI measurement resources, the UE 702 may select the one or more first CLI measurement resources for determining one or more CLI measurements. As another example, when the UL transmission having the one or more first CLI measurement resources has a lower timing offset compared to the dedicated tracking loop than the UL transmission having the one or more second CLI measurement resources, the UE 702 may select the one or more first CLI measurement resources for determining one or more CLI measurements. As yet another example, when the UL transmission having the one or more first CLI measurement resources has a lower frequency offset compared to the dedicated tracking loop than the UL transmission having the one or more second CLI measurement resources, the UE 702 may select the one or more first CLI measurement resources for determining one or more CLI measurements.

In some aspects, the UE 702 may include at least two dedicated tracking loops for receiving at least two UL transmissions each having one or more CLI measurement resources sharing a same symbol. For example, the indication may indicate that the one or more first CLI measurement resources and the one or more second CLI measurement resources are in a same CLI measurement resource group and are to be received concurrently by the UE 702 in one or more overlapping symbols. Because the one or more first CLI measurement resources and the one or more second CLI measurement resources are in a same CLI measurement resource group, the UE 702 may use a first dedicated tracking loop to receive the one or more first CLI measurement resources to determine one or more CLI measurements and a second dedicated tracking loop to receive the one or more second CLI measurement resources to determine one or more CLI measurements.

In some aspects, the UE 702 may have two tracking loops. The indication may indicate to the UE 702 that the one or more first CLI measurement resources are in a first CLI measurement group and the one or more second CLI measurement resources are in a second CLI measurement resource group. Each of the one or more first CLI measurement resources and the one or more second CLI measurement resources are to be received concurrently by the UE 702 in one or more overlapping symbols. The indication may also indicate to the UE 702 that the UE 702 is to receive another UL transmission including one or more third CLI measurement resources of a third CLI measurement group. One or more different priority values may be assigned (e.g., by the UE 702 or by the scheduling entity 704 via the indication) to each of the first CLI measurement resource group, the second CLI measurement resource group, and the third CLI measurement resource group. The UE 702 may select the one or more first CLI measurement resources for reception using the first tracking loop based on one or more first priority values relative to the one or more second priority values and/or the one or more third priority values. The UE 702 may also select the one or more second CLI measurement resources for reception using the second tracking loop based on one or more second priority values relative to the one or more first priority values and/or the one or more third priority values. Additionally, the UE 702 may abstain from receiving the one or more third CLI measurement resource based on one or more third priority values relative to the one or more first priority values and/or the one or more second priority values. The UE 702 may then determine one or more CLI measurements using the one or more first CLI measurement resources and the one or more second CLI measurement resources.

At 714, the UE 702 may determine one or more CLI measurements for the at least two CLI measurement resources based on the at least two measurement resources being received in the one or more same symbols of the at least two concurrent UL transmissions and being within the same CLI measurement resource group of the one or more CLI measurement resource group. For example, after the first UE 802 receives the at least two CLI measurement resources of the plurality of CLI measurement resource in one or more same symbols of at least two concurrent UL transmissions using at least one dedicated tracking loop, the first UE 802 may determine one or more CLI measurements of the at least two UL transmissions, for example, from two other sources (e.g., aggressor UEs). The one or more CLI measurements may include at least one of sound reference signal (SRS), a reference signal received strength (RSRP), or a received signal strength indicator (RSSI).

At 716, the UE 702 may transmit a CLI measurement report including the one or more CLI measurements to the scheduling entity 704. For example, after determining the one or more CLI measurements, the UE 702 may transmit a measurement report to the scheduling entity 704 so that the scheduling entity 704 and/or a network associated with the scheduling entity 704 may manage the scheduling of the UE 702 and/or one or more other sources (e.g., one or more other UEs) to balance the throughput of at least one of the UE 702 and the one or more other sources.

In some aspects, a victim UE may assume that no dedicated tracking loops are used for CLI measurement. For example, a reception (RX) timing of a CLI resource may be a same timing as a victim UE's transmission (TX) timing. As another example, an FTL and an AGC of a server cell DL signal/channel RX may be reused for CLI measurement. In some cases, a CLI that is 10 dB weaker than serving cell PDSCH may cap the carrier to interference plus noise ratio (CINR) at 10 dB and the corresponding maximum modulation and coding scheme (MCS). In some cases, when at a cell edge, a CLI may be even stronger than the serving cell PDSCH. For both cases, the CLI measurement accuracy may be impacted if a same AGC is used to receive the CLI due to either serious truncation or saturation of the CLI resource. In some aspects, the victim UE may not even be able to identify the sequence if the CLI resource is a sounding reference signal (SRS).

To avoid this problem, dedicated tracking loops may be used for CLI measurement. Unlike network serving cell DL signals (e.g., CSI-RS, synchronization signal block (SSB)), a CLI measurement resource from the aggressor UE may have an abrupt change. For example, a sharp change of CLI power may be due to an aggressor UE's dynamic TX power sharing for UL carrier aggregation (CA) or dynamic TX power aggregation. An abrupt frequency change may be due to TX frequency pre-compensation of an aggressor UE in high-speed train (HST) scenario when the aggressor UE passes by the remote radio head (RRH). In some aspects, TX timing advance of an aggressor UE may also jump due to a timing advance (TA) adjustment. However, to enable a victim UE's dedicated tracking loops to smoothly track the timing, frequency, and/or power of CLI and quickly converge, a network can configure the timing, frequency, and gain information to victim UE whenever there is an abrupt change.

A first UE may receive, from a scheduling entity, one or more indications of one or more parameters associated with an uplink (UL) transmission from a second UE, wherein the UL transmission includes one or more cross link interference (CLI) measurement resources. The first UE may also configure one or more dedicated tracking loops for receiving the one or more CLI measurement resources of the UL transmission based on the one or more indications of the one or more parameters. The first UE may further receive, from the second UE, the one or more CLI measurement resources of the UL transmission using the one or more dedicated tracking loops according to the one or more parameters, while also receiving a downlink (DL) transmission from the scheduling entity. In addition, the first UE may determine one or more CLI measurements using the one or more CLI measurement resources of the UL transmission. The first UE may further transmit, to the scheduling entity, a CLI measurement report indicating the one or more CLI measurements associated with the one or more CLI measurement resources of the UL transmission.

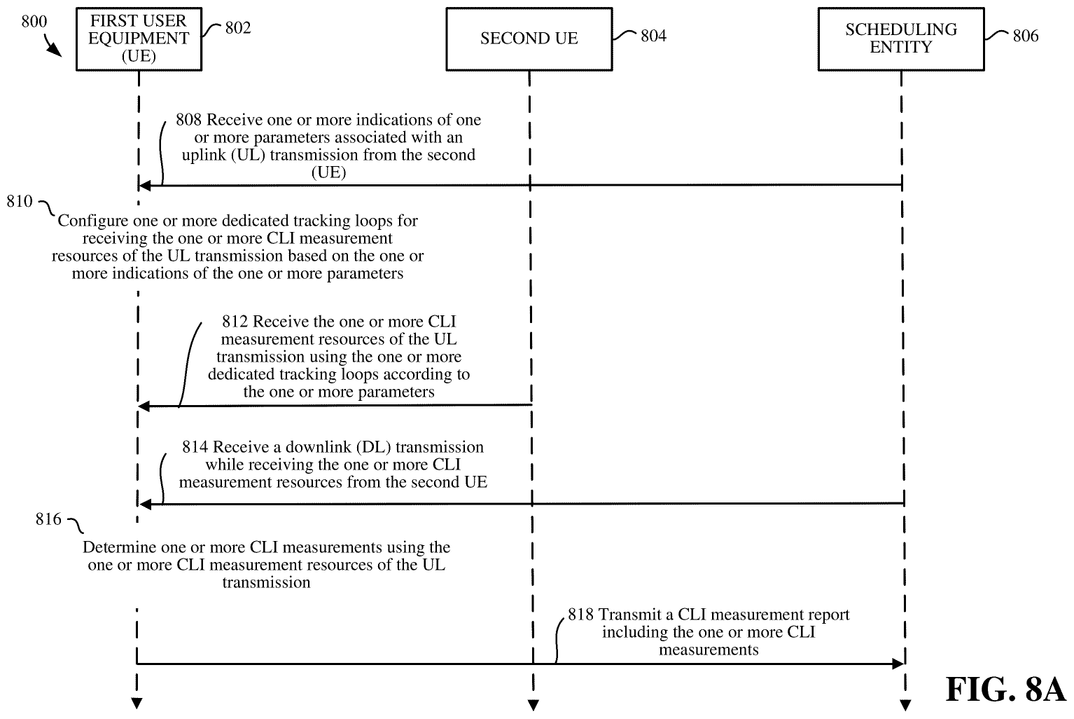

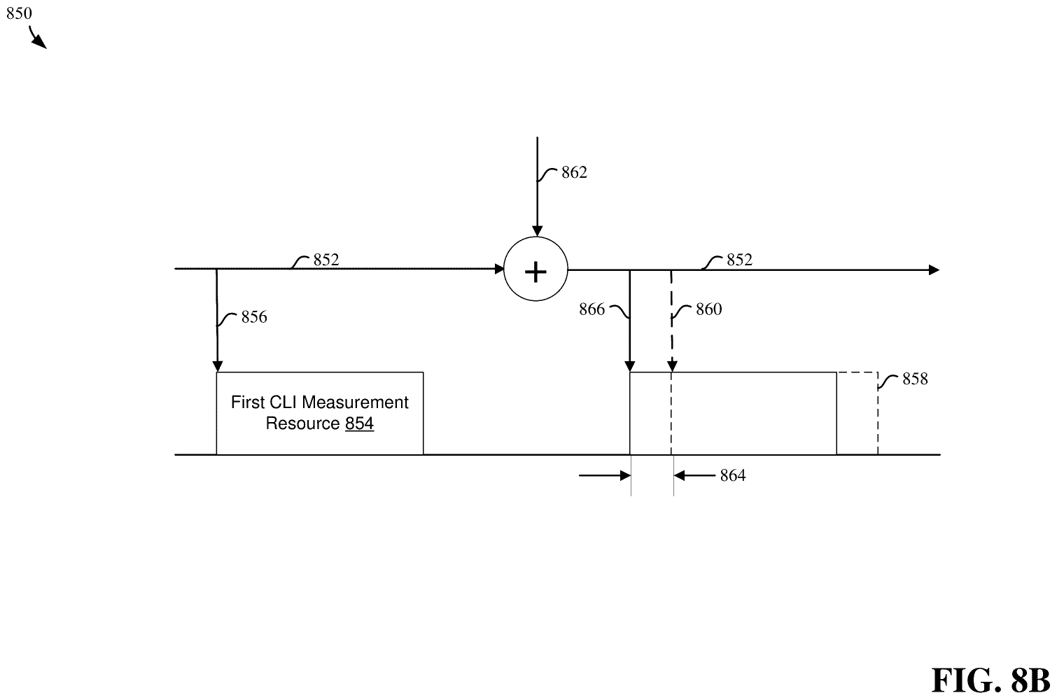

FIG. 8A is a conceptual diagram illustrating an example environment 800 for dynamic reconfiguration of CLI measurement resources according to some aspects. In the example shown in FIG. 8A, a first user equipment (UE) 802 (e.g., a victim UE) is in wireless communication a second UE 804 (e.g., an aggressor UE) and a scheduling entity 806 over one or more wireless communication links. Each of the first UE 802, the second UE 804, and the scheduling entity 806 may correspond to any of the entities, gNodeBs, UEs, or the like as shown in FIGS. 1-4, and 7.

At 808, the first UE 802 may receive, from the scheduling entity 806, one or more indications of one or more parameters associated with an UL transmission from the second UE 804. The UL transmission may include one or more cross link interference (CLI) measurement resources. For example, the scheduling entity 806 may configure one or more parameters (such as timing offset, frequency offset, and/or power information) into the indication for the first UE 802 because the second UE 804 is in a connected mode with the scheduling entity 806 and the scheduling entity 806 is aware and/or controls changes to the one or more parameters.

In some cases, the scheduling entity 806 may transmit the one or more indications to the first UE 802 using one or more radio resource control (RRC) messages (e.g., for level 3 CLI measurement). However, reconfiguring CLI measurement resources through RRC introduces signaling overhead and long application delays. In some aspects, the scheduling entity 806 may transmit the one or more indications to the first UE 802 using at least one of one or more medium access control (MAC) control elements (MAC-CE) or one or more physical downlink control channels (PDCCH) (e.g., for level 1 CLI measurement). Transmitting the one or more indications in MAC-CEs and/or a PDCCH may provide a dynamic indication that reduces signal overhead while increasing speed and efficiency. In some cases, when the one or more indications are transmitted in MAC-CEs and/or a PDCCH, the one or more indications may include a triggering signal that triggers the first UE 802 to measure one or more CLI measurement resource in one or more slots.

In some aspects, the first UE 802 may maintain one or more dedicated tracking loops for each configured CLI measurement resource. In some cases, multiple CLI measurement resources (e.g., from a same aggressor) may share a same dedicated tracking loop. For a configured CLI measurement resource, the scheduling entity 806 may transmit one or more indications to the first UE 802 indicating one or more changes to one or more parameters. The first UE 802 may use the information of the one or more indications to update one or more dedicated tracking loops of the first UE 802 to receive the first CLI measurement resources and the second CLI measurement resources. For example, the scheduling entity 806 may configure a timing advance change to an UL transmission of the second UE 804. The scheduling entity 806 may transmit one or more indications of the timing advance change of the second UE 804 to the first UE 802 to update the first UE 802. The first UE 802 may then update its one or more tracking loops (e.g., a dedicated TTL) according to the timing advance change to receive the CLI measurement resources in the UL transmission from the second UE 804.

Additionally, or alternatively, the scheduling entity 806 may configure a power change and/or a frequency offset change to an UL transmission of the second UE 804 and transmit one or more indications of the power change and/or the frequency offset change of the second UE 804 to the first UE 802 to update one or more dedicated tracking loops of the first UE 802. The first UE 802 may then update its one or more dedicated tracking loops according to the power change (e.g., one or more dedicated digital and/or analog AGCs) and/or the frequency offset change (e.g., one or more dedicated FTLs) to receive the CLI measurement resources in the UL transmission from the second UE 804. In some aspects, when the one or more parameters includes a power change that causes a gain change of the first UE's 802 analog AGC, the first UE 802 may be allowed to skip CLI measurements of corresponding CLI measurement resources within a duration of time after receiving the one or more indications of the power change from the scheduling entity 806. In some aspects, the scheduling entity 806 may configure a frequency change to an UL transmission of the second UE 804, after the second UE 804 passes a radio resource head (RRH) in a high-speed train (HST) scenario, transmit one or more indications having one or more parameters including a frequency change of the UL transmission to the first UE 802 so that the first UE 802 may update one or more of its FTL to receive one or more CLI measurement resources of the UL transmission.

In some aspects, the one or more indications having one or more parameters that is transmitted from the scheduling entity 806 to the first UE 802 may include a signal indication to indicate a change of a plurality of parameters including power, timing offset, frequency offset, or the like for a corresponding UL transmission from the second UE 804. Using a single indication to indicate a change of a plurality of parameters may provide a compact signal design. Once the first UE 802 receives the single indication from the scheduling entity 806, the first UE 802 may reset one or more (e.g., all) of its tracking loops for the CLI measurement resources from the UL transmission of the second UE 804. A reset of the tracking loops may use a fresh acquisition of the one or more parameters which may cause a wider pull-in range and may be more complicated than individual parameters for individual tracking loops.

In some aspects, the one or more indications having one or more parameters that are transmitted from the scheduling entity 806 to the first UE 802 may include a plurality of indications so that each indication of the plurality of indications includes a single parameter to indicate a parameter change of one of a power, timing offset, frequency offset, or the like for a corresponding UL transmission from the second UE 804. Using individual indications to indicate individual parameter changes may allow the first UE 802 to separately update each of its tracking loops. For example, the indication may only indicate that a timing advance of the second UE 804 has been changed or updated. The first UE 802 upon receiving the indication may maintain current operation of its AGC and FTL for the CLI measurement resources from an UL transmission of the second UE 804 while changing or updating the TTL.

In some aspects, the one or more indications may indicate that one or more parameters of one or more CLI measurement resources of an UL transmission from the second UE 804 have changed. In some aspects, the one or more indications may include an amount of change of the one or more parameters. Alternatively, the one or more indications may include only an indication that one or more parameters have change, but do not indicate an amount of change of the one or more parameters. In some cases, when the one or more indications indicate a plurality of parameters (e.g., parameter changes) for one or more CLI measurement resources of an UL transmission from the second UE 804, the indication may be transmitted from the scheduling entity 806 to the first UE 802 via a transmission configuration indicator (TCI) state information message. In some aspects, the TCI state information message may not include a quasi-colocation (QCL) source and/or may indicate which one or more parameters have been changed. For example, TCI state of zero (0) and one (1) may be configured for the CLI measurement resources and a change between zero (0) and one (1) may indicate a change of one or more parameters of the second UE's 804 UL transmission.

At 810, the first UE 802 may configure one or more dedicated tracking loops for receiving the one or more CLI measurement resources of the UL transmission based on the one or more indications of the one or more parameters. For example, the first UE 802 may receive, from the scheduling entity 806, one or more indications having one or more parameters for configuring one or more CLI measurement resources from an UL transmission from the second UE 804. After receiving the one or more indications, the first UE 802 may configure (e.g., reconfigure) one or more tracking loops of the first UE 802 to receive and measure one or more CLI measurement resources of the UL transmission from the second UE 804.

At 812, the first UE 802 may receive, from the second UE 804, the one or more CLI measurement resources of the UL transmission using the one or more dedicated tracking loops according to the one or more parameters, and, at 814, the first UE 802 may receive a downlink (DL) transmission from the scheduling entity 806 while receiving the one or more CLI measurement resources from the second UE 804. In some aspects, the UL transmission from the second UE 804 may be for reception by the scheduling entity 806. Additionally, or alternatively, the UL transmission from the second UE 804 may be for reception by one or more other scheduling entities other than the scheduling entity 806. After configuring one or more tracking loops of the first UE 802 to receive one or more CLI measurement resources of an UL transmission from the second UE 804, the first UE 802 may receive the one or more CLI measurement resources of the UL transmission from the second UE 804 using the one or more configured tracking loops for measuring one or more CLI measurements. At the same time, the scheduling entity 806 may transmit a DL transmission to the first UE 802. The UL transmission from the second UE 804 and the DL transmission from the scheduling entity 806 may both be received by the first UE 802 causing cross link interference (CLI).

At 816, the first UE 802 may determine one or more CLI measurements using the one or more CLI measurement resources of the UL transmission. For example, after the first UE 802 receives the one or more CLI measurement resources of the UL transmission from the second UE 804 using the one or more configured tracking loops for measuring one or more CLI measurement, the first UE 802 may measure the one or more measurements of the UL transmission from the second UE 804. The one or more CLI measurements may include at least one of sound reference signal (SRS), a reference signal received strength (RSRP), or a received signal strength indicator (RSSI).

At 818, the first UE 802 may transmit a CLI measurement report including the one or more CLI measurements. For example, after determining the one or more CLI measurements, the first UE 802 may transmit a measurement report to the scheduling entity 806 so that the scheduling entity 806 and/or a network associated with the scheduling entity 806 may manage the scheduling of the second UE 804 and the first UE 802 to balance the throughput of both the second UE 804 and the first UE 802.

FIG. 8B is a conceptual diagram illustrating an example of a configuration 850 of a CLI measurement resource according to some aspects. As shown in FIG. 8B, a victim UE (e.g., the first UE 802 illustrated in FIG. 8A) may have at least one tracking loop 852 for receiving one or more CLI measurement resources of one or more UL transmissions from one or more aggressor UEs (e.g., the second UE 804 illustrated in FIG. 8A). The victim UE may receive a first CLI measurement resource 854 of an UL transmission at a first time 854. The victim UE may determine one or more CLI measures using the first CLI measurement resource 854. The victim UE may also expect to receive a second CLI measurement resource 858 of an UL transmission at a second time 860 after receiving the first CLI measurement resource 854 at the first time 856. However, before the victim UE receives a second CLI measurement resource 858, the victim UE may receive an indication 862 of a timing adjustment 864 (e.g., configuration, reconfiguration) of the second CLI measurement resource 858 so that the victim UE receives the second CLI measurement resource 858 at a third time 866. Thus, the victim UE may receive the second CLI measurement resource 858 at the third time 866 to determine one or more CLI measurements using the second CLI measurement resource 858.

As described herein, after determining one or more CLI measurements using at least the second CLI measurement resource 858 received at the third time 866, the victim UE may transmit a measurement report to a scheduling entity (e.g., the scheduling entity 806 of FIG. 8A) so that the scheduling entity and/or a network associated with the scheduling entity may manage the scheduling of one or more aggressor UEs and the victim UE to balance the throughput of both the one or more aggressor UEs and the victim UE. It should be understood that while FIG. 8B illustrates that the indication 862 causes the timing adjustment 864 to move the reception of the second CLI measurement resource 858 from the second time 860 to an earlier third time 866, the indication 862 may alternatively cause the timing adjustment 864 to move the reception of the second CLI measurement resource 858 from the second time 860 to a time that is later than the second time 860. In some aspects, the indication 862 may cause the timing adjustment 864 to maintain the reception of the second CLI measurement resource 858 at the second time 860 and not move the reception of the second CLI measurement resource 858 to an earlier time or a later time. It should also be understood that while FIG. 8B illustrates that the indication 862 causes a timing adjustment 864, the indication 862 may additionally, or alternatively, cause a frequency adjustment and/or a power adjustment as described herein.

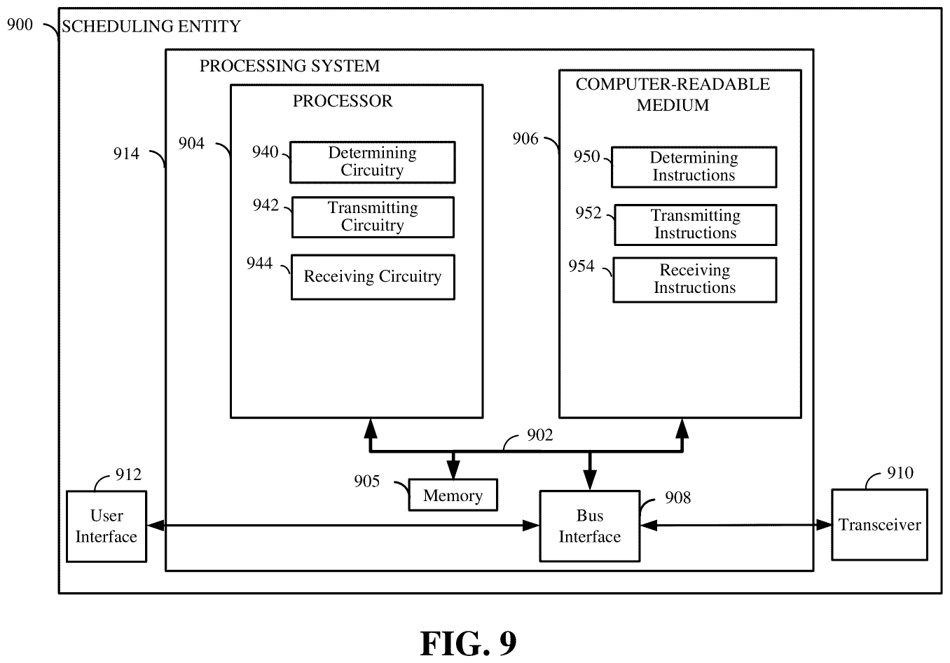

FIG. 9 is a block diagram illustrating an example of a hardware implementation for a scheduling entity 900 employing a processing system 914. For example, the scheduling entity 900 may be any of the user equipment (UEs) or base stations (e.g., gNB or eNB) illustrated in any one or more of FIGS. 1-4, 7, and 8A.

The scheduling entity 900 may be implemented with a processing system 914 that includes one or more processors 904. Examples of processors 904 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the scheduling entity 900 may be configured to perform any one or more of the functions described herein. That is, the processor 904, as utilized in the scheduling entity 900, may be used to implement any one or more of the processes described herein. The processor 904 may in some instances be implemented via a baseband or modem chip and in other implementations, the processor 904 may itself comprise a number of devices distinct and different from a baseband or modem chip (e.g., in such scenarios that may work in concert to achieve aspects discussed herein). And as mentioned above, various hardware arrangements and components outside of a baseband modem processor can be used in implementations, including RF-chains, power amplifiers, modulators, buffers, interleavers, adders/summers, etc.

In this example, the processing system 914 may be implemented with a bus architecture, represented generally by the bus 902. The bus 902 may include any number of interconnecting buses and bridges depending on the specific application of the processing system 914 and the overall design constraints. The bus 902 communicatively couples together various circuits including one or more processors (represented generally by the processor 904), and computer-readable media (represented generally by the computer-readable storage medium 906). The bus 902 may also link various other circuits such as timing sources, peripherals, voltage regulators, and power management circuits, which are well known in the art, and therefore, will not be described any further. A bus interface 908 provides an interface between the bus 902 and a transceiver 910. The transceiver 910 provides a means for communicating with various other apparatus over a transmission medium (e.g., air interface). A user interface 912 (e.g., keypad, display, speaker, microphone, joystick) may also be provided.

The processor 904 is responsible for managing the bus 902 and general processing, including the execution of software stored on the computer-readable storage medium 906. The software, when executed by the processor 904, causes the processing system 914 to perform the various functions described herein for any particular apparatus. The computer-readable storage medium 906 may also be used for storing data that is manipulated by the processor 904 when executing software.

One or more processors 904 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable storage medium 906.

The computer-readable storage medium 906 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable storage medium 906 may reside in the processing system 914, external to the processing system 914, or distributed across multiple entities including the processing system 914. The computer-readable storage medium 906 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

In some aspects of the disclosure, the processor 904 may include circuitry configured for various functions. For example, the processor 904 may include determining circuitry 940 configured to determine one or more parameters associated with an uplink (UL) transmission from a second user equipment (UE), where the UL transmission includes one or more cross link interference (CLI) measurement resources. The determining circuitry 940 may be configured to execute determining instructions 950 stored in the computer-readable storage medium 906 to implement any of the one or more of the functions described herein.

The processor 904 may also include transmitting circuitry 942 configured to transmit, to a first UE, one or more indications of the one or more parameters associated with the UL transmission for configuring one or more dedicated tracking loops for receiving the one or more CLI measurement resources of the UL transmission. The transmitting circuitry 942 may also be configured to transmit, to the first UE, a downlink (DL) transmission while the second UE transmits the UL transmission. The transmitting circuitry 942 may be further configured to transmit an indication to a first use equipment (UE) that a plurality of cross link interference (CLI) measurement resources is within a same CLI measurement resource group of one or more CLI measurement resource groups. In addition, the transmitting circuitry 942 may be configured to transmit a downlink (DL) transmission to the first UE when the first UE receives at least two CLI measurement resources of the plurality of CLI measurement resources in one or more same symbols of at least two concurrent uplink (UL) transmissions using at least one dedicated tracking loop. The transmitting circuitry 942 may be configured to execute transmitting instructions 952 stored in the computer-readable storage medium 906 to implement any of the one or more of the functions described herein.

The processor 904 may further include receiving circuitry 944 configured to receive a measurement report from the first UE including one or more CLI measurements obtained from the one or more CLI measurement resources associated with the UL transmission. The receiving circuitry 944 may also be configured to receive a CLI measurement report including one or more CLI measurements for the at least two CLI measurement resources based on the at least two CLI measurement resources being received in the one or more same symbols of the at least two concurrent UL transmissions and being within the same CLI measurement resource group of the one or more CLI measurement resource groups. The receiving circuitry 944 may be further configured to receive, from the first UE, an indication that the first UE supports concurrent reception of the plurality of CLI measurement resources using a plurality of dedicated tracking loops. The receiving circuitry 944 may be configured to execute receiving instructions 954 stored in the computer-readable storage medium 906 to implement any of the one or more of the functions described herein.

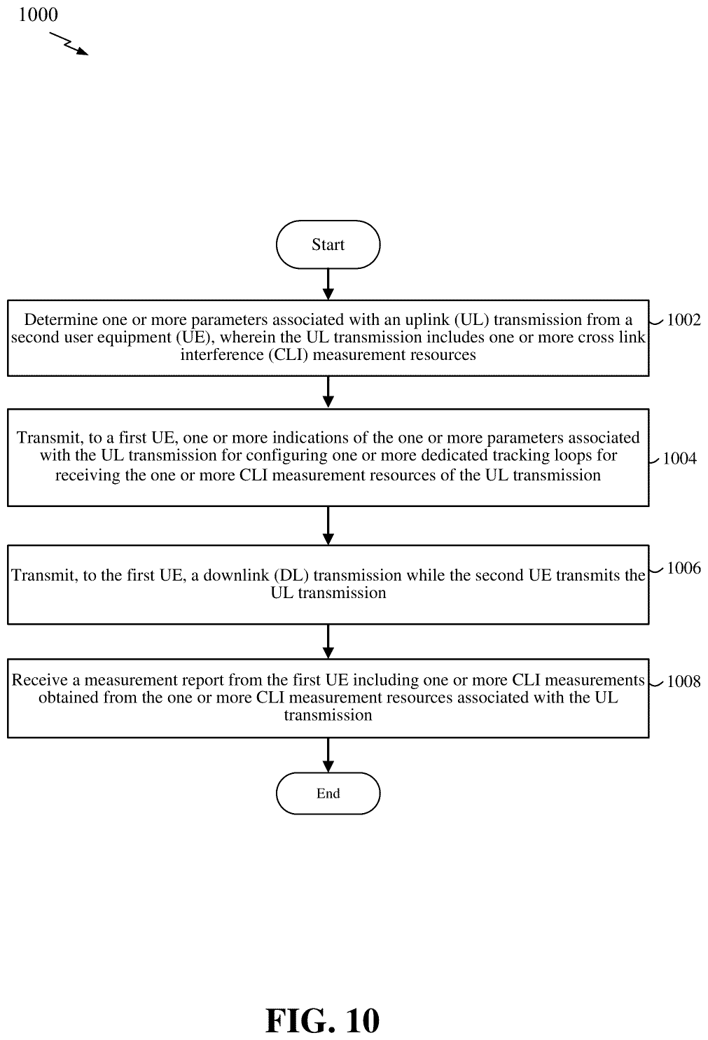

FIG. 10 is a flow chart of a method 1000 for dynamic reconfiguration of CLI measurement resources according to some aspects. As described below, some or all illustrated features may be omitted in a particular implementation within the scope of the present disclosure, and some illustrated features may not be required for implementation of all aspects. In some examples, the method may be performed by the scheduling entity 900, as described herein, and illustrated in FIG. 9, by a processor or processing system, or by any suitable means for carrying out the described functions.

At block 1002, the scheduling entity 900 may determine one or more parameters associated with an uplink (UL) transmission from a second user equipment (UE), where the UL transmission includes one or more cross link interference (CLI) measurement resources. In some aspects, wherein the one or more indications of the one or more parameters associated with the UL transmission may include at least one indication of one or more changed parameters associated with the UL transmission. In some aspects, the one or more parameters may include at least one of a power of at least one CLI measurement resource of the one or more CLI measurement resources, a frequency of at least one CLI measurement resource of the one or more CLI measurement resources, or a timing advance of at least one CLI measurement resource of the one or more CLI measurement resources.

In some aspects, the one or more indications of the one or more parameters may include a first indication of a first parameter associated with a first dedicated tracking loop of the one or more dedicated tracking loops, and a second indication of a second parameter associated with a second dedicated tracking loop of the one or more dedicated tracking loops. In some aspects, the one or more indications of the one or more parameters may include at least one indication of a plurality of parameters associated with at least one dedicated tracking loop of the one or more dedicated tracking loops. In some aspects, the one or more indications of the one or more parameters associated with an UL transmission from a second UE may be transmitted by the scheduling entity via at least one of a medium access control (MAC) control element (MAC-CE), a physical downlink control channel (PDCCH), or a radio resource control (RRC) message. In some aspects, the one or more indications may be included in transmission configuration indicator (TCI) state information.

In some aspects, each dedicated tracking loop of the one or more dedicated tracking loops may be associated with a single CLI measurement resource of the one or more CLI measurement resources. In some aspects, each dedicated tracking loop of the one or more dedicated tracking loops may be associated with a plurality of CLI measurement resources of the one or more CLI measurement resources. In some aspects, determining the one or more parameters associated with the UL transmission may include scheduling the one or more parameters associated with the UL transmission. The determining circuitry 940, shown and described above in connection with FIG. 9 may provide a means to determine one or more parameters associated with an uplink (UL) transmission from a second user equipment (UE), where the UL transmission includes one or more cross link interference (CLI) measurement resources.

At block 1004, the scheduling entity 900 may transmit, to a first UE, one or more indications of the one or more parameters associated with the UL transmission for configuring one or more dedicated tracking loops for receiving the one or more CLI measurement resources of the UL transmission. In some aspects, transmitting the one or more indications of the one or more parameters to the first UE triggers the first UE to determine the one or more CLI measurements. The transmitting circuitry 942 together with the transceiver 910, shown and described above in connection with FIG. 9 may provide a means to transmit, to a first UE, one or more indications of the one or more parameters associated with the UL transmission for configuring one or more dedicated tracking loops for receiving the one or more CLI measurement resources of the UL transmission.

At block 1006, the scheduling entity 900 may transmit, to the first UE, a downlink (DL) transmission while the second UE transmits the UL transmission. The transmitting circuitry 942 together with the transceiver 910, shown and described above in connection with FIG. 9 may provide a means to transmit, to the first UE, a DL transmission while the second UE transmits the UL transmission.

At block 1008, the scheduling entity 900 may receive a measurement report from the first UE including one or more CLI measurements obtained from the one or more CLI measurement resources associated with the UL transmission. In some aspects, the first UE may transmit a measurement report to the scheduling entity 900 so that the scheduling entity 900 and/or a network associated with the scheduling entity 900 may manage the scheduling of the first UE and/or the second UE to balance the throughput of at least one of the first UE or the second UE. In some aspects, the one or more CLI measurements may include at least one of sound reference signal (SRS), a reference signal received strength (RSRP), or a received signal strength indicator (RSSI). The receiving circuitry 944 together with the transceiver 910, shown and described above in connection with FIG. 9 may provide a means to receive a measurement report from the first UE including one or more CLI measurements obtained from the one or more CLI measurement resources associated with the UL transmission.

In one configuration, the scheduling entity 900 includes means for performing the various functions and processes described in relation to FIG. 9. In one aspect, the aforementioned means may be the processor 904 shown in FIG. 9 configured to perform the functions recited by the aforementioned means. In another aspect, the aforementioned means may be a circuit or any apparatus configured to perform the functions recited by the aforementioned means.

Of course, in the above examples, the circuitry included in the processor 904 is merely provided as an example, and other means for carrying out the described functions may be included within various aspects of the present disclosure, including but not limited to the instructions stored in the computer-readable storage medium 906, or any other suitable apparatus or means described in any one of the FIGS. 1-4, 7, and 8A and utilizing, for example, the processes and/or algorithms described herein in relation to FIG. 10.

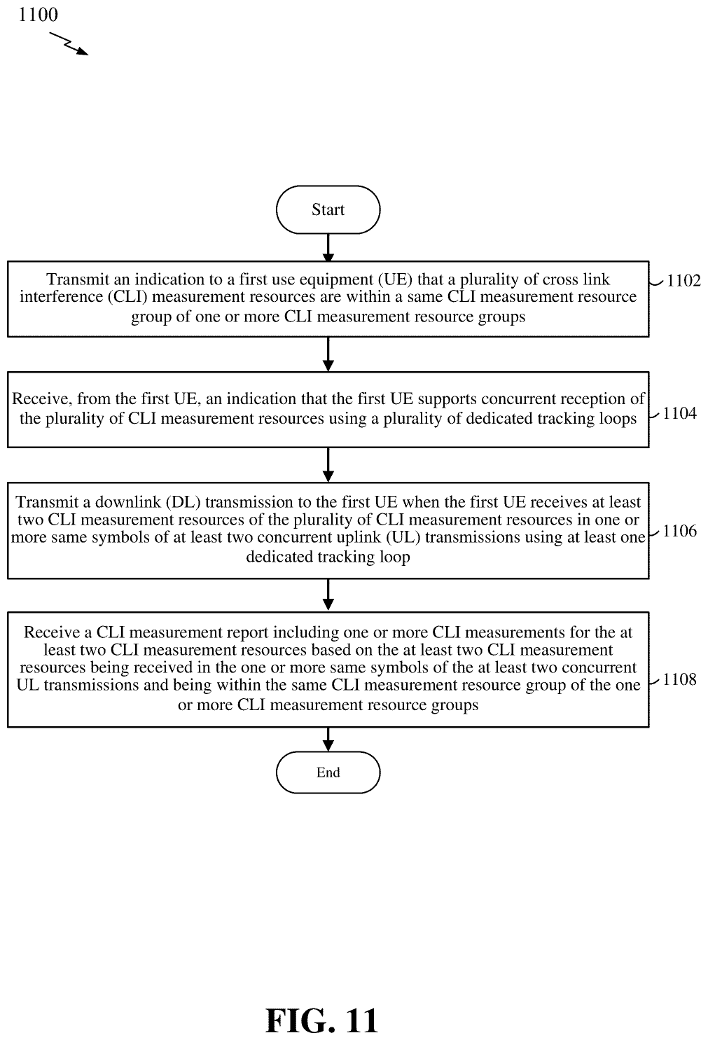

FIG. 11 is a flow chart of a method 1100 for concurrent measurement of multiple CLI measurement resources according to some aspects. As described below, some or all illustrated features may be omitted in a particular implementation within the scope of the present disclosure, and some illustrated features may not be required for implementation of all aspects. In some examples, the method may be performed by the scheduling entity 900, as described herein, and illustrated in FIG. 9, by a processor or processing system, or by any suitable means for carrying out the described functions.

At block 1102, the scheduling entity 900 may transmit an indication to a first use equipment (UE) that a plurality of cross link interference (CLI) measurement resources is within a same CLI measurement resource group of one or more CLI measurement resource groups. In some aspects, transmitting the indication to the first UE that the plurality of cross link interference (CLI) measurement resources are within the same CLI measurement resource group of the one or more CLI measurement resource groups may include transmitting, to the first UE, an indication of one or more common parameters of the CLI measurement resource group for the first UE to determine that the plurality of measurement resources are within the CLI measurement resource group based on the one or more common parameters. In some aspects, the one or more common parameters may include at least one of a same or similar power, a same or similar timing, or a same or similar frequency.

In some aspects, the indication to the first UE that the plurality of cross link interference (CLI) measurement resources are within the same CLI measurement resource group of one or more CLI measurement resource groups may include at least that a first plurality of CLI measurement resources are within a first same CLI measurement resource group of the one or more CLI measurement resource groups, and a second plurality of CLI measurement resources are within a second same CLI measurement resource group of the one or more CLI measurement resource groups. In some aspects, the one or more CLI measurements may be based on a first priority value of the first same CLI measurement resource group and a second priority value of the second same CLI measurement resource group. In some aspects, the first priority value and the second priority value may be assigned by the scheduling entity or determined by the first UE. In some aspects, the first priority value and the second priority value may be determined based on a first distance between the first UE and first source of a first concurrent UL transmission of the at least two concurrent UL transmissions and on a second distance between the first UE and second source of a second concurrent UL transmission of the at least two concurrent UL transmissions. In some aspects, the first priority value may be based on a first power of a first concurrent UL transmission of the at least two concurrent UL transmissions, and the second priority value may be based on a second power of a second concurrent UL transmission of the at least two concurrent UL transmissions. The transmitting circuitry 942 together with the transceiver 910, shown and described above in connection with FIG. 9 may provide a means to transmit an indication to a first use equipment (UE) that a plurality of cross link interference (CLI) measurement resources is within a same CLI measurement resource group of one or more CLI measurement resource groups.

At block 1104, the scheduling entity 900 may receive, from the first UE, an indication that the first UE supports concurrent reception of the plurality of CLI measurement resources using a plurality of dedicated tracking loops. In some aspects, the indication that the first UE supports concurrent reception of the plurality of CLI measurement resources using the plurality of dedicated tracking loops may include an indication of a maximum quantity of dedicated tracking loops of the first UE for receiving the plurality of CLI measurement resources. In some aspects, the indication that the first UE supports concurrent reception of the plurality of CLI measurement resources using the plurality of dedicated tracking loops may include an indication of a maximum quantity of same symbols of the one or more symbols that each of the at least two dedicated tracking loops of the first UE are configured to utilize for receiving the plurality of CLI measurement resources. The receiving circuitry 944 together with the transceiver 910, shown and described above in connection with FIG. 9 may provide a means to receive, from the first UE, an indication that the first UE supports concurrent reception of the plurality of CLI measurement resources using a plurality of dedicated tracking loops.

At block 1106, the scheduling entity 900 may transmit a DL transmission to the first UE when the first UE receives at least two CLI measurement resources of the plurality of CLI measurement resources in one or more same symbols of at least two concurrent uplink (UL) transmissions using at least one dedicated tracking loop. In some aspects, the at least one dedicated tracking loop may include only one dedicated tracking loop dedicated to the CLI measurement group. In some aspects, the at least one dedicated tracking loop may include at least two dedicated tracking loops. In some aspects, the at least two CLI measurement resources of the plurality of CLI measurement resources in the one or more same symbols of at least two concurrent UL transmissions may include at least a first CLI measurement resource of the plurality of CLI measurement resources for reception by a first dedicated tracking loop, and a second CLI measurement resource of the plurality of CLI measurement resources for reception by a second dedicated tracking loop. The transmitting circuitry 942 together with the transceiver 910, shown and described above in connection with FIG. 9 may provide a means to transmit a DL transmission to the first UE when the first UE receives at least two CLI measurement resources of the plurality of CLI measurement resources in one or more same symbols of at least two concurrent uplink (UL) transmissions using at least one dedicated tracking loop.

At block 1108, the scheduling entity 900 may receive a CLI measurement report including one or more CLI measurements for the at least two CLI measurement resources based on the at least two CLI measurement resources being received in the one or more same symbols of the at least two concurrent UL transmissions and being within the same CLI measurement resource group of the one or more CLI measurement resource groups. In some aspects, the first UE may transmit a measurement report to the scheduling entity 900 so that the scheduling entity 900 and/or a network associated with the scheduling entity 900 may manage the scheduling of the first UE and/or one or more other sources (e.g., one or more other UEs) to balance the throughput of at least one of the first UE and the one or more other sources. In some aspects, the one or more CLI measurements may include at least one of sound reference signal (SRS), a reference signal received strength (RSRP), or a received signal strength indicator (RSSI). The receiving circuitry 944 together with the transceiver 910, shown and described above in connection with FIG. 9 may provide a means to receive a CLI measurement report including one or more CLI measurements for the at least two CLI measurement resources based on the at least two CLI measurement resources being received in the one or more same symbols of the at least two concurrent UL transmissions and being within the same CLI measurement resource group of the one or more CLI measurement resource groups.

In one configuration, the scheduling entity 900 includes means for performing the various functions and processes described in relation to FIG. 11. In one aspect, the aforementioned means may be the processor 904 shown in FIG. 9 configured to perform the functions recited by the aforementioned means. In another aspect, the aforementioned means may be a circuit or any apparatus configured to perform the functions recited by the aforementioned means.

Of course, in the above examples, the circuitry included in the processor 904 is merely provided as an example, and other means for carrying out the described functions may be included within various aspects of the present disclosure, including but not limited to the instructions stored in the computer-readable storage medium 906, or any other suitable apparatus or means described in any one of the FIGS. 1-4, 7, 8A, 8B, and 9 and utilizing, for example, the processes and/or algorithms described herein in relation to FIG. 11.

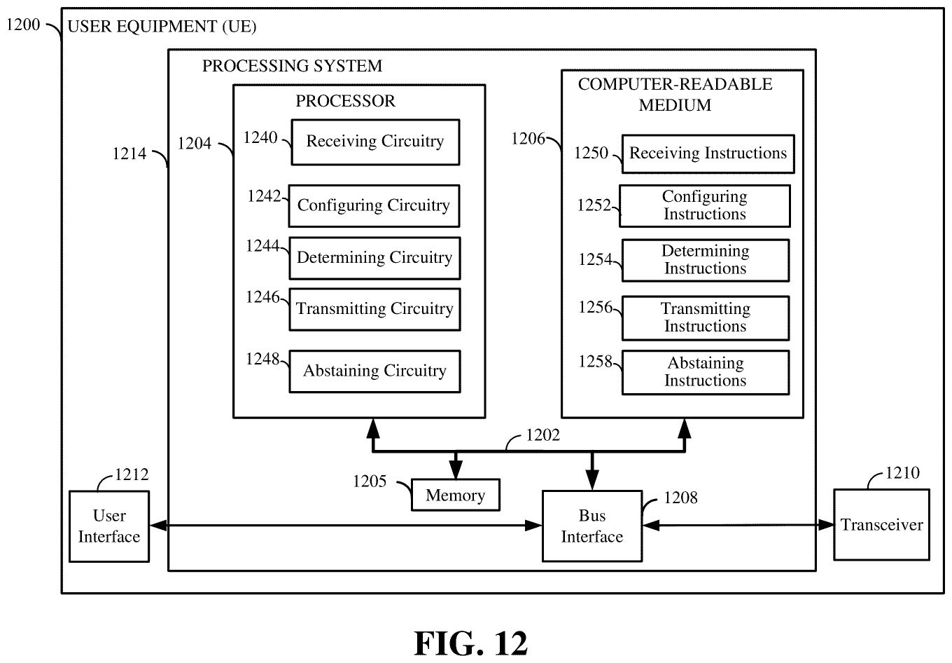

FIG. 12 is a block diagram illustrating an example of a hardware implementation for a user equipment (UE) 1200 employing a processing system 1214 according to some aspects. For example, the UE 1200 may correspond to any of the devices or systems shown and described herein in any one or more of FIGS. 1-4, 7, 8A, 8B, and 9.

In accordance with various aspects of the disclosure, an element, or any portion of an element, or any combination of elements may be implemented with a processing system 1214 that includes one or more processors 1204. The processing system 1214 may be substantially the same as the processing system 914 illustrated in FIG. 9, including a bus interface 1208, a bus 1202, a processor 1204, and a computer-readable storage medium 1206. Furthermore, the UE 1200 may include a user interface 1212 and a transceiver 1210 substantially similar to those described above in FIG. 9. That is, the processor 1204, as utilized in the UE 1200, may be used to implement any one or more of the processes described herein.

In some aspects of the disclosure, the processor 1204 may include circuitry configured for various functions. For example, the processor 1204 may include receiving circuitry 1240 configured to receive, from a scheduling entity, one or more indications of one or more parameters associated with an uplink (UL) transmission from a second UE, where the UL transmission includes one or more cross link interference (CLI) measurement resources. The receiving circuitry 1240 may also be configured to receive, from the second UE, the one or more CLI measurement resources of the UL transmission using the one or more dedicated tracking loops according to the one or more parameters, while also receiving a downlink (DL) transmission from the scheduling entity. The receiving circuitry 1240 may be further configured to receive at least two CLI measurement resources of the plurality of CLI measurement resources in one or more same symbols of at least two concurrent uplink (UL) transmissions using at least one dedicated tracking loop, while also receiving a downlink (DL) transmission from a scheduling entity. The receiving circuitry 1240 may be configured to execute receiving instructions 1250 stored in the computer-readable storage medium 1206 to implement any of the one or more of the functions described herein.

The processor 1204 may also include configuring circuitry 1242 configured to configure one or more dedicated tracking loops for receiving the one or more CLI measurement resources of the UL transmission based on the one or more indications of the one or more parameters. The configuring circuitry 1242 may further be configured to execute configuring instructions 1252 stored in the computer-readable storage medium 1206 to implement any of the one or more of the functions described herein.

The processor 1204 may further include determining circuitry 1244 configured to determine one or more CLI measurements using the one or more CLI measurement resources of the UL transmission. The determining circuitry 1244 may also be configured to determine that a plurality of cross link interference (CLI) measurement resources is within a same CLI measurement resource group of one or more CLI measurement resource groups. The determining circuitry 1244 may be further configured to determine one or more CLI measurements for the at least two CLI measurement resources based on the at least two CLI measurement resources being received in the one or more same symbols of the at least two concurrent UL transmissions and being within the same CLI measurement resource group of the one or more CLI measurement resource groups. The determining circuitry 1244 may be configured to execute determining instructions 1254 stored in the computer-readable storage medium 1206 to implement any of the one or more of the functions described herein.

In addition, the processor 1204 may include transmitting circuitry 1246 configured to transmit, to the scheduling entity, a CLI measurement report indicating the one or more CLI measurements associated with the one or more CLI measurement resources of the UL transmission. The transmitting circuitry 1246 may also be configured to transmit an indication that the first UE supports concurrent reception of the plurality of CLI measurement resources using a plurality of dedicated tracking loops. The transmitting circuitry 1246 may be configured to execute transmitting instructions 1256 stored in the computer-readable storage medium 1206 to implement any of the one or more of the functions described herein.

The processor 1204 may also include abstaining circuitry 1248 configured to abstain, for a predetermined duration of time, from receiving one or more CLI measurements using the at least one CLI measurement resources of the UL transmission when the power exceeds a threshold power difference from a previous power. The abstaining circuitry 1248 may be configured to execute abstaining instructions 1258 stored in the computer-readable storage medium 1206 to implement any of the one or more of the functions described herein.

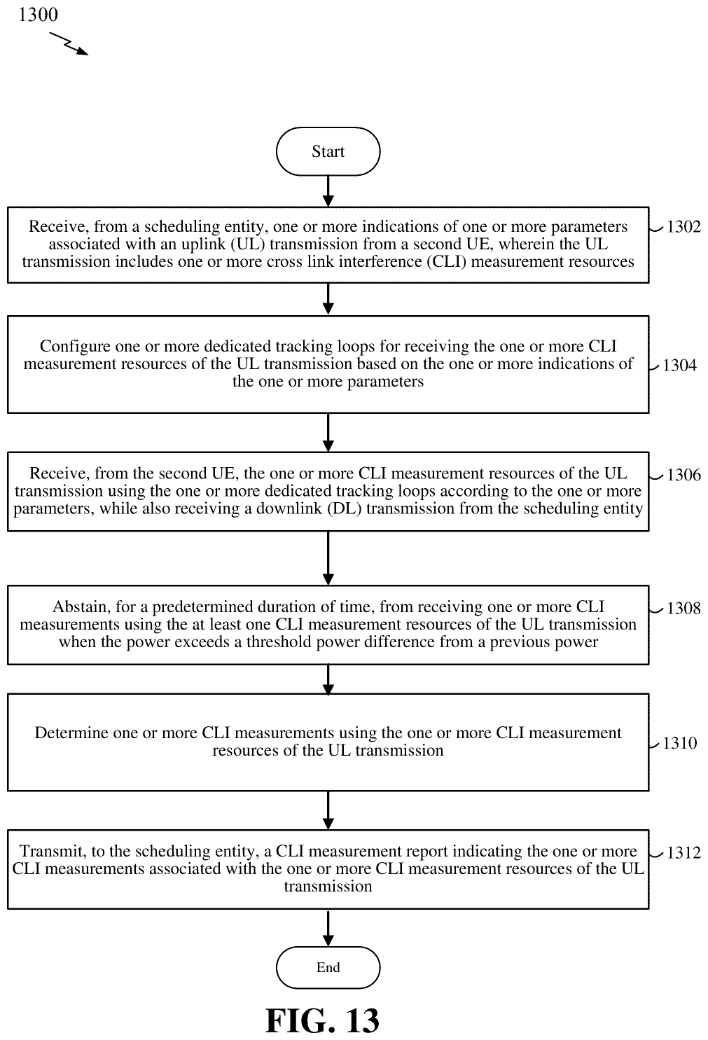

FIG. 13 is a flow chart of a method 1300 for dynamic reconfiguration of CLI measurement resources according to some aspects. As described below, some or all illustrated features may be omitted in a particular implementation within the scope of the present disclosure, and some illustrated features may not be required for implementation of all aspects. In some examples, the method may be performed by the UE 1200, as described herein, and illustrated in FIG. 12, by a processor or processing system, or by any suitable means for carrying out the described functions.

At block 1302, the UE 1200 may receive, from a scheduling entity, one or more indications of one or more parameters associated with an uplink (UL) transmission from a second UE, where the UL transmission includes one or more cross link interference (CLI) measurement resources. In some aspects, the one or more indications of the one or more parameters associated with the UL transmission may include at least one indication of one or more changed parameters associated with the UL transmission. In some aspects, the one or more parameters may include at least one of a power of at least one CLI measurement resource of the one or more CLI measurement resources, a frequency of at least one CLI measurement resource of the one or more CLI measurement resources, or a timing advance of at least one CLI measurement resource of the one or more CLI measurement resources.

In some aspects, the one or more indications of the one or more parameters may include a first indication of a first parameter associated with a first dedicated tracking loop of the one or more dedicated tracking loops, and a second indication of a second parameter associated with a second dedicated tracking loop of the one or more dedicated tracking loops. In some aspects, the one or more indications of the one or more parameters may include at least one indication of a plurality of parameters associated with at least one dedicated tracking loop of the one or more dedicated tracking loops. In some aspects, the one or more indications of the one or more parameters associated with an UL transmission from a second UE may be received from the scheduling entity via at least one of a medium access control (MAC) control element (MAC-CE), a physical downlink control channel (PDCCH), or a radio resource control (RRC) message. In some aspects, one or more indications may be included in transmission configuration indicator (TCI) state information. In some aspects, the one or more parameters may be determined and/or scheduled by the scheduling entity.

The receiving circuitry 1240 together with the transceiver 1210, shown and described above in connection with FIG. 12 may provide a means to receive, from a scheduling entity, one or more indications of one or more parameters associated with an uplink (UL) transmission from a second UE, where the UL transmission includes one or more cross link interference (CLI) measurement resources.

At block 1304, the UE 1200 may configure one or more dedicated tracking loops for receiving the one or more CLI measurement resources of the UL transmission based on the one or more indications of the one or more parameters. In some aspects, each dedicated tracking loop of the one or more dedicated tracking loops may be associated with a single CLI measurement resource of the one or more CLI measurement resources. In some aspects, each dedicated tracking loop of the one or more dedicated tracking loops may be associated with a plurality of CLI measurement resources of the one or more CLI measurement resources. The configuring circuitry 1242, shown and described above in connection with FIG. 12 may provide a means to configure one or more dedicated tracking loops for receiving the one or more CLI measurement resources of the UL transmission based on the one or more indications of the one or more parameters.

At block 1306, the UE 1200 may receive, from the second UE, the one or more CLI measurement resources of the UL transmission using the one or more dedicated tracking loops according to the one or more parameters, while also receiving a downlink (DL) transmission from the scheduling entity. The receiving circuitry 1240 together with the transceiver 1210, shown and described above in connection with FIG. 12 may provide a means to receive, from the second UE, the one or more CLI measurement resources of the UL transmission using the one or more dedicated tracking loops according to the one or more parameters, while also receiving a downlink (DL) transmission from the scheduling entity.

At block 1308, the UE 1200 may abstain, for a predetermined duration of time, from receiving one or more CLI measurements using the at least one CLI measurement resources of the UL transmission when the power exceeds a threshold power difference from a previous power. In some aspects, the UE 1200 may abstain, for a predetermined duration of time, from receiving one or more CLI measurements using the at least one CLI measurement resources of the UL transmission when the power exceeds a threshold power difference from a previous power when the one or more parameters include at least the power of the at least one CLI measurement resource of the one or more CLI measurement resources. The abstaining circuitry 1248, shown and described above in connection with FIG. 12 may provide a means to abstain, for a predetermined duration of time, from receiving one or more CLI measurements using the at least one CLI measurement resources of the UL transmission when the power exceeds a threshold power difference from a previous power.

At block 1310, the UE 1200 may determine one or more CLI measurements using the one or more CLI measurement resources of the UL transmission. In some aspects, the one or more CLI measurements may include at least one of sound reference signal (SRS), a reference signal received strength (RSRP), or a received signal strength indicator (RSSI). In some aspects, the UE 1200 may determine the one or more CLI measurements in response to receiving the one or more indications of the one or more parameters via a PDCCH. The determining circuitry 1244, shown and described above in connection with FIG. 12 may provide a means to determine one or more CLI measurements using the one or more CLI measurement resources of the UL transmission.

At block 1312, the UE 1200 may transmit, to the scheduling entity, a CLI measurement report indicating the one or more CLI measurements associated with the one or more CLI measurement resources of the UL transmission. In some aspects, the UE 1200 may transmit a measurement report to the scheduling entity so that the scheduling entity and/or a network associated with the scheduling entity may manage the scheduling of the UE and/or the second UE to balance the throughput of at least one of the UE 1200 or the second UE. The transmitting circuitry 1246 together with the transceiver 1210, shown and described above in connection with FIG. 12 may provide a means to transmit, to the scheduling entity, a CLI measurement report indicating the one or more CLI measurements associated with the one or more CLI measurement resources of the UL transmission.

In one configuration, the UE 1200 includes means for performing the various functions and processes described in relation to FIG. 13. In one aspect, the aforementioned means may be the processor 1204 shown in FIG. 12 configured to perform the functions recited by the aforementioned means. In another aspect, the aforementioned means may be a circuit or any apparatus configured to perform the functions recited by the aforementioned means.

Of course, in the above examples, the circuitry included in the processor 1204 is merely provided as an example, and other means for carrying out the described functions may be included within various aspects of the present disclosure, including but not limited to the instructions stored in the computer-readable storage medium 1206, or any other suitable apparatus or means described in any one of the FIGS. 1-4, 7, 8A, 8B, and 9-12 and utilizing, for example, the processes and/or algorithms described herein in relation to FIG. 13.

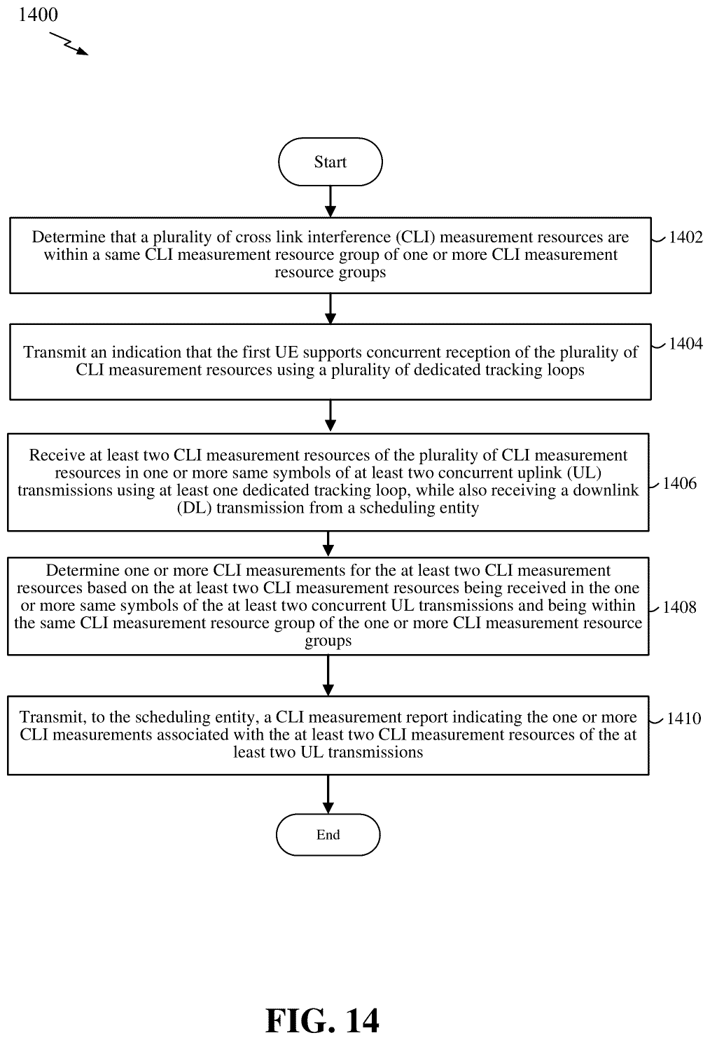

FIG. 14 is a flow chart of a method 1400 for concurrent measurement of multiple CLI measurement resources according to some aspects. As described below, some or all illustrated features may be omitted in a particular implementation within the scope of the present disclosure, and some illustrated features may not be required for implementation of all aspects. In some examples, the method may be performed by the UE 1200, as described herein, and illustrated in FIG. 12, by a processor or processing system, or by any suitable means for carrying out the described functions.

At block 1402, the UE 1200 may determine that a plurality of cross link interference (CLI) measurement resources is within a same CLI measurement resource group of one or more CLI measurement resource groups. In some aspects, determining that the plurality of measurement resources is within the CLI measurement resource group may include receiving one or more indications from the scheduling entity that the plurality of measurement resources is within the CLI measurement resource group. In some aspects, determining that the plurality of measurement resources is within the CLI measurement resource group may include receiving, from the scheduling entity, an indication of one or more common parameters of the CLI measurement resource group, and determining that the plurality of measurement resources is within the CLI measurement resource group based on the one or more common parameters. In some aspects, the one or more common parameters may include at least one of a same or similar power, a same or similar timing, or a same or similar frequency.

In some aspects, determining that the plurality of CLI measurement resources are within the same CLI measurement resource group of the one or more CLI measurement resource groups may include at least determining that a first plurality of CLI measurement resources are within a first same CLI measurement resource group of the one or more CLI measurement resource groups, and determining that a second plurality of CLI measurement resources are within a second same CLI measurement resource group of the one or more CLI measurement resource groups. In some aspects, when determining that the plurality of CLI measurement resources are within the same CLI measurement resource group of the one or more CLI measurement resource groups includes at least determining that a first plurality of CLI measurement resources are within a first same CLI measurement resource group of the one or more CLI measurement resource groups, and determining that a second plurality of CLI measurement resources are within a second same CLI measurement resource group of the one or more CLI measurement resource groups, the UE 1200 may also determining that a quantity of CLI measurement resource groups exceeds a reception capability of the first UE, determining a first priority value of the first same CLI measurement resource group and a second priority value of the second same CLI measurement resource group, selecting either the first same CLI measurement resource group or the second same CLI measurement resource group based on whether the first priority value or the second priority value is a greater value, and receiving either the first same CLI measurement resource group or the second same CLI measurement resource group in the one or more same symbols of at least two concurrent UL transmissions using at least one dedicated tracking loop while receiving a downlink (DL) transmission from a scheduling entity based on whether the first priority value or the second priority value is selected.

In some aspects, the first priority value and the second priority value may be assigned by the scheduling entity or determined by the first UE. In some aspects, the first priority value and the second priority value may be determined based on a first distance between the first UE and first source of a first concurrent UL transmission of the at least two concurrent UL transmissions and on a second distance between the first UE and second source of a second concurrent UL transmission of the at least two concurrent UL transmissions. In some aspects, the first priority value may be based on a first power of a first concurrent UL transmission of the at least two concurrent UL transmissions, and the second priority value may be based on a second power of a second concurrent UL transmission of the at least two concurrent UL transmissions.

The determining circuitry 1244, shown and described above in connection with FIG. 12 may provide a means to determine that a plurality of cross link interference (CLI) measurement resources is within a same CLI measurement resource group of one or more CLI measurement resource groups.

At block 1404, the UE 1200 may transmit an indication that the UE 1200 supports concurrent reception of the plurality of CLI measurement resources using a plurality of dedicated tracking loops. In some aspects, the indication that the first UE supports concurrent reception of the plurality of CLI measurement resources using the plurality of dedicated tracking loops may include an indication of a maximum quantity of dedicated tracking loops of the first UE for receiving the plurality of CLI measurement resources. In some aspects, the indication that the first UE supports concurrent reception of the plurality of CLI measurement resources using the plurality of dedicated tracking loops may include an indication of a maximum quantity of same symbols of the one or more symbols that each of the at least two dedicated tracking loops of the first UE are configured to utilize for receiving the plurality of CLI measurement resources.

The transmitting circuitry 1246, shown and described above in connection with FIG. 12 may provide a means to transmit an indication that the UE supports concurrent reception of the plurality of CLI measurement resources using a plurality of dedicated tracking loops.

At block 1406, the UE 1200 may receive at least two CLI measurement resources of the plurality of CLI measurement resources in one or more same symbols of at least two concurrent uplink (UL) transmissions using at least one dedicated tracking loop, while also receiving a downlink (DL) transmission from a scheduling entity. In some aspects, the at least one dedicated tracking loop may include only one dedicated tracking loop dedicated to the CLI measurement group. In some aspects, the at least one dedicated tracking loop comprises at least two dedicated tracking loops, and where receiving the at least two CLI measurement resources of the plurality of CLI measurement resources in the one or more same symbols of at least two concurrent UL transmissions may include at least receiving a first CLI measurement resource of the plurality of CLI measurement resources using a first dedicated tracking loop while receiving the DL transmission from the scheduling entity, and receiving a second CLI measurement resource of the plurality of CLI measurement resources using a second dedicated tracking loop while receiving the DL transmission from the scheduling entity.

The receiving circuitry 1240 together with the transceiver 1210, shown and described above in connection with FIG. 12 may provide a means to receive at least two CLI measurement resources of the plurality of CLI measurement resources in one or more same symbols of at least two concurrent uplink (UL) transmissions using at least one dedicated tracking loop, while also receiving a downlink (DL) transmission from a scheduling entity.

At block 1408, the UE 1200 may determine one or more CLI measurements for the at least two CLI measurement resources based on the at least two CLI measurement resources being received in the one or more same symbols of the at least two concurrent UL transmissions and being within the same CLI measurement resource group of the one or more CLI measurement resource groups. In some aspects, the one or more CLI measurements may include at least one of sound reference signal (SRS), a reference signal received strength (RSRP), or a received signal strength indicator (RSSI).

The determining circuitry 1244, shown and described above in connection with FIG. 12 may provide a means to determine one or more CLI measurements for the at least two CLI measurement resources based on the at least two CLI measurement resources being received in the one or more same symbols of the at least two concurrent UL transmissions and being within the same CLI measurement resource group of the one or more CLI measurement resource groups.

At block 1410, the UE 1200 may transmit, to the scheduling entity, a CLI measurement report indicating the one or more CLI measurements associated with the at least two CLI measurement resources of the at least two UL transmissions. In some aspects, the UE 1200 may transmit a measurement report to the scheduling entity so that the scheduling entity and/or a network associated with the scheduling entity may manage the scheduling of the UE 1200 and/or one or more other sources (e.g., one or more other UEs) to balance the throughput of at least one of the UE 1200 and the one or more other sources. The transmitting circuitry 1246, shown and described above in connection with FIG. 12 may provide a means to transmit, to the scheduling entity, a CLI measurement report indicating the one or more CLI measurements associated with the at least two CLI measurement resources of the at least two UL transmissions.

In one configuration, the UE 1200 includes means for performing the various functions and processes described in relation to FIG. 14. In one aspect, the aforementioned means may be the processor 1204 shown in FIG. 12 configured to perform the functions recited by the aforementioned means. In another aspect, the aforementioned means may be a circuit or any apparatus configured to perform the functions recited by the aforementioned means.

Of course, in the above examples, the circuitry included in the processor 1204 is merely provided as an example, and other means for carrying out the described functions may be included within various aspects of the present disclosure, including but not limited to the instructions stored in the computer-readable storage medium 1206, or any other suitable apparatus or means described in any one of the FIGS. 1-4, 7, 8A, 8B, and 9-13 and utilizing, for example, the processes and/or algorithms described herein in relation to FIG. 14.

In a first aspect, a UE may receive, from a scheduling entity, one or more indications of one or more parameters associated with an uplink (UL) transmission from a second UE, where the UL transmission includes one or more cross link interference (CLI) measurement resources. The UE may also configure one or more dedicated tracking loops for receiving the one or more CLI measurement resources of the UL transmission based on the one or more indications of the one or more parameters. The UE may further receive, from the second UE, the one or more CLI measurement resources of the UL transmission using the one or more dedicated tracking loops according to the one or more parameters, while also receiving a downlink (DL) transmission from the scheduling entity. In addition, the UE may determine one or more CLI measurements using the one or more CLI measurement resources of the UL transmission.

In a second aspect, alone or in combination with the first aspect, the UE may further transmit, to the scheduling entity, a CLI measurement report indicating the one or more CLI measurements associated with the one or more CLI measurement resources of the UL transmission.

In a third aspect, alone or in combination with one or more of the first and second aspects, the one or more indications of the one or more parameters associated with the UL transmission may include at least one indication of one or more changed parameters associated with the UL transmission.

In a fourth aspect, alone or in combination with one or more of the first through third aspects, the one or more parameters may include at least one of a power of at least one CLI measurement resource of the one or more CLI measurement resources, a frequency of at least one CLI measurement resource of the one or more CLI measurement resources, or a timing advance of at least one CLI measurement resource of the one or more CLI measurement resources.

In a fifth aspect, alone or in combination with one or more of the first through fourth aspects, when the one or more parameters comprise at least the power of the at least one CLI measurement resource of the one or more CLI measurement resources, the UE may further abstain, for a predetermined duration of time, from receiving one or more CLI measurements using the at least one CLI measurement resources of the UL transmission when the power exceeds a threshold power difference from a previous power.

In a sixth aspect, alone or in combination with one or more of the first through fifth aspects, the one or more indications of the one or more parameters may include a first indication of a first parameter associated with a first dedicated tracking loop of the one or more dedicated tracking loops and a second indication of a second parameter associated with a second dedicated tracking loop of the one or more dedicated tracking loops.

In a seventh aspect, alone or in combination with one or more of the first through sixth aspects, the one or more indications of the one or more parameters may include at least one indication of a plurality of parameters associated with at least one dedicated tracking loop of the one or more dedicated tracking loops.

In an eighth aspect, alone or in combination with one or more of the first through seventh aspects, the one or more indications of the one or more parameters associated with an UL transmission from a second UE may be received from the scheduling entity via at least one of a medium access control (MAC) control element (MAC-CE), a physical downlink control channel (PDCCH), or a radio resource control (RRC) message.

In a ninth aspect, alone or in combination with one or more of the first through eighth aspects, the one or more indications may be included in transmission configuration indicator (TCI) state information.

In a tenth aspect, alone or in combination with one or more of the first through nineth aspects, each dedicated tracking loop of the one or more dedicated tracking loops may be associated with a single CLI measurement resource of the one or more CLI measurement resources.

In an eleventh aspect, alone or in combination with one or more of the first through tenth aspects, each dedicated tracking loop of the one or more dedicated tracking loops may be associated with a plurality of CLI measurement resources of the one or more CLI measurement resources.

In a twelfth aspect, alone or in combination with one or more of the first through eleventh aspects, the one or more parameters may be determined by the scheduling entity.

In a thirteenth aspect, alone or in combination with one or more of the first through twelfth aspects, the one or more parameters may be scheduled by the scheduling entity.

In a fourteenth aspect, alone or in combination with one or more of the first through thirteenth aspects, the first UE may determine the one or more CLI measurements in response to receiving the one or more indications of the one or more parameters via a PDCCH.

In a fifteenth aspect, alone or in combination with one or more of the first through fourteenth aspects, the one or more CLI measurements may include at least one of sound reference signal (SRS), a reference signal received strength (RSRP), or a received signal strength indicator (RSSI).

In a sixteenth aspect, a scheduling entity may determine one or more parameters associated with an uplink (UL) transmission from a second user equipment (UE), where the UL transmission includes one or more cross link interference (CLI) measurement resources. The scheduling entity may also transmit, to a first UE, one or more indications of the one or more parameters associated with the UL transmission for configuring one or more dedicated tracking loops for receiving the one or more CLI measurement resources of the UL transmission. The scheduling entity may further transmit, to the first UE, a downlink (DL) transmission while the second UE transmits the UL transmission. In addition, the scheduling entity may receive a measurement report from the first UE including one or more CLI measurements obtained from the one or more CLI measurement resources associated with the UL transmission.

In a seventeenth aspect, alone or in combination with the sixteenth aspect, the one or more indications of the one or more parameters associated with the UL transmission may include at least one indication of one or more changed parameters associated with the UL transmission.

In an eighteenth aspect, alone or in combination with the sixteenth aspect and the seventeenth aspect, the one or more parameters may include at least one of a power of at least one CLI measurement resource of the one or more CLI measurement resources, a frequency of at least one CLI measurement resource of the one or more CLI measurement resources, or a timing advance of at least one CLI measurement resource of the one or more CLI measurement resources.

In a nineteenth aspect, alone or in combination with the sixteenth through the eighteenth aspect, the one or more indications of the one or more parameters may include a first indication of a first parameter associated with a first dedicated tracking loop of the one or more dedicated tracking loops; and a second indication of a second parameter associated with a second dedicated tracking loop of the one or more dedicated tracking loops.

In a twentieth aspect, alone or in combination with the sixteenth through the nineteenth aspect, the one or more indications of the one or more parameters may include at least one indication of a plurality of parameters associated with at least one dedicated tracking loop of the one or more dedicated tracking loops.

In a twenty-first aspect, alone or in combination with the sixteenth through the twentieth aspect, the one or more indications of the one or more parameters associated with an UL transmission from a second UE may be transmitted by the scheduling entity via at least one of a medium access control (MAC) control element (MAC-CE), a physical downlink control channel (PDCCH), or a radio resource control (RRC) message.

In a twenty-second aspect, alone or in combination with the sixteenth through the twenty-first aspect, the one or more indications may be included in transmission configuration indicator (TCI) state information.

In a twenty-third aspect, alone or in combination with the sixteenth through the twenty-second aspect, each dedicated tracking loop of the one or more dedicated tracking loops may be associated with a single CLI measurement resource of the one or more CLI measurement resources.

In a twenty-fourth aspect, alone or in combination with the sixteenth through the twenty-third aspect, each dedicated tracking loop of the one or more dedicated tracking loops may be associated with a plurality of CLI measurement resources of the one or more CLI measurement resources.

In a twenty-fifth aspect, alone or in combination with the sixteenth through the twenty-fourth aspect, the scheduling entity determining the one or more parameters associated with the UL transmission may include the scheduling entity scheduling the one or more parameters associated with the UL transmission.

In a twenty-sixth aspect, alone or in combination with the sixteenth through the twenty-fifth aspect, the scheduling entity transmitting the one or more indications of the one or more parameters to the first UE triggers the first UE to determine the one or more CLI measurements.

In a twenty-seventh aspect, alone or in combination with the sixteenth through the twenty-sixth aspect, the one or more CLI measurements may include at least one of sound reference signal (SRS), a reference signal received strength (RSRP), or a received signal strength indicator (RSSI).

In a twenty-eighth aspect, a first UE may determine that a plurality of cross link interference (CLI) measurement resources is within a same CLI measurement resource group of one or more CLI measurement resource groups. The first UE may also receive at least two CLI measurement resources of the plurality of CLI measurement resources in one or more same symbols of at least two concurrent uplink (UL) transmissions using at least one dedicated tracking loop, while also receiving a downlink (DL) transmission from a scheduling entity. The first UE may further determine one or more CLI measurements for the at least two CLI measurement resources based on the at least two CLI measurement resources being received in the one or more same symbols of the at least two concurrent UL transmissions and being within the same CLI measurement resource group of the one or more CLI measurement resource groups.

In a twenty-nineth aspect, alone or in combination with the twenty-eighth aspect, determining that the plurality of measurement resources is within the CLI measurement resource group may include receiving one or more indications from the scheduling entity that the plurality of measurement resources is within the CLI measurement resource group.

In a thirtieth aspect, alone or in combination with one or more of the twenty-eighth and twenty-nineth aspects, determining that the plurality of measurement resources is within the CLI measurement resource group may include receiving, from the scheduling entity, an indication of one or more common parameters of the CLI measurement resource group; and determining that the plurality of measurement resources is within the CLI measurement resource group based on the one or more common parameters.

In a thirty-first aspect, alone or in combination with one or more of the twenty-eighth through thirtieth aspects, the one or more common parameters may include at least one of a same or similar power, a same or similar timing, or a same or similar frequency.

In a thirty-second aspect, alone or in combination with one or more of the twenty-eighth through thirty-first aspects, the at least one dedicated tracking loop may include only one dedicated tracking loop dedicated to the CLI measurement group.

In a thirty-third aspect, alone or in combination with one or more of the twenty-eighth through thirty-second aspects, the at least one dedicated tracking loop comprises at least two dedicated tracking loops, and receiving the at least two CLI measurement resources of the plurality of CLI measurement resources in the one or more same symbols of at least two concurrent UL transmissions may include at least receiving a first CLI measurement resource of the plurality of CLI measurement resources using a first dedicated tracking loop while receiving the DL transmission from the scheduling entity, and receiving a second CLI measurement resource of the plurality of CLI measurement resources using a second dedicated tracking loop while receiving the DL transmission from the scheduling entity.

In a thirty-fourth aspect, alone or in combination with one or more of the twenty-eighth through thirty-third aspects, the UE may further transmit an indication that the first UE supports concurrent reception of the plurality of CLI measurement resources using a plurality of dedicated tracking loops.

In a thirty-fifth aspect, alone or in combination with the thirty-fourth aspect, the indication that the first UE supports concurrent reception of the plurality of CLI measurement resources using the plurality of dedicated tracking loops may include an indication of a maximum quantity of dedicated tracking loops of the first UE for receiving the plurality of CLI measurement resources.

In a thirty-sixth aspect, alone or in combination with the thirty-fourth and thirty-fifth aspects, the indication that the first UE supports concurrent reception of the plurality of CLI measurement resources using the plurality of dedicated tracking loops may include an indication of a maximum quantity of same symbols of the one or more symbols that each of the at least two dedicated tracking loops of the first UE are configured to utilize for receiving the plurality of CLI measurement resources.

In a thirty-seventh aspect, alone or in combination with the thirty-third aspect, determining that the plurality of CLI measurement resources is within the same CLI measurement resource group of the one or more CLI measurement resource groups may include at least determining that a first plurality of CLI measurement resources are within a first same CLI measurement resource group of the one or more CLI measurement resource groups, and determining that a second plurality of CLI measurement resources are within a second same CLI measurement resource group of the one or more CLI measurement resource groups, the UE may further determine that a quantity of CLI measurement resource groups exceeds a reception capability of the first UE, determine a first priority value of the first same CLI measurement resource group and a second priority value of the second same CLI measurement resource group, select either the first same CLI measurement resource group or the second same CLI measurement resource group based on whether the first priority value or the second priority value is a greater value, and receive either the first same CLI measurement resource group or the second same CLI measurement resource group in the one or more same symbols of at least two concurrent UL transmissions using at least one dedicated tracking loop while receiving a downlink (DL) transmission from a scheduling entity based on whether the first priority value or the second priority value is selected.

In a thirty-eighth aspect, alone or in combination with the thirty-seventh aspect, the first priority value and the second priority value may be assigned by the scheduling entity or determined by the first UE.

In a thirty-nineth aspect, alone or in combination with the thirty-seventh and thirty-eighth aspects, the first priority value and the second priority value may be determined based on a first distance between the first UE and first source of a first concurrent UL transmission of the at least two concurrent UL transmissions and on a second distance between the first UE and second source of a second concurrent UL transmission of the at least two concurrent UL transmissions.

In a fortieth aspect, alone or in combination with the thirty-seventh and thirty-nineth aspects, the first priority value may be based on a first power of a first concurrent UL transmission of the at least two concurrent UL transmissions, and the second priority value may be based on a second power of a second concurrent UL transmission of the at least two concurrent UL transmissions.

In a forty-first aspect, a scheduling entity may transmit an indication to a first use equipment (UE) that a plurality of cross link interference (CLI) measurement resources is within a same CLI measurement resource group of one or more CLI measurement resource groups. The scheduling entity may also transmit a downlink (DL) transmission to the first UE when the first UE receives at least two CLI measurement resources of the plurality of CLI measurement resources in one or more same symbols of at least two concurrent uplink (UL) transmissions using at least one dedicated tracking loop. The scheduling entity may further receive a CLI measurement report including one or more CLI measurements for the at least two CLI measurement resources based on the at least two CLI measurement resources being received in the one or more same symbols of the at least two concurrent UL transmissions and being within the same CLI measurement resource group of the one or more CLI measurement resource groups.

In a forty-second aspect, alone or in combination with the forty-first aspect, transmitting the indication to the first UE that the plurality of cross link interference (CLI) measurement resources is within the same CLI measurement resource group of the one or more CLI measurement resource groups may include transmitting, to the first UE, an indication of one or more common parameters of the CLI measurement resource group for the first UE to determine that the plurality of measurement resources is within the CLI measurement resource group based on the one or more common parameters.

In a forty-third aspect, alone or in combination with the forty-first and forty-second aspects, the one or more common parameters may include at least one of a same or similar power, a same or similar timing, or a same or similar frequency.

In a forty-fourth aspect, alone or in combination with the forty-first through forty-third aspects, the at least one dedicated tracking loop may include only one dedicated tracking loop dedicated to the CLI measurement group.

In a forty-fifth aspect, alone or in combination with the forty-first through forty-fourth aspects, the at least one dedicated tracking loop may include at least two dedicated tracking loops, and the at least two CLI measurement resources of the plurality of CLI measurement resources in the one or more same symbols of at least two concurrent UL transmissions may include at least a first CLI measurement resource of the plurality of CLI measurement resources for reception by a first dedicated tracking loop, and a second CLI measurement resource of the plurality of CLI measurement resources for reception by a second dedicated tracking loop.

In a forty-sixth aspect, alone or in combination with the forty-fifth aspect, the scheduling entity may further receive, from the first UE, an indication that the first UE supports concurrent reception of the plurality of CLI measurement resources using a plurality of dedicated tracking loops.

In a forty-seventh aspect, alone or in combination with the forty-sixth aspect, the indication that the first UE supports concurrent reception of the plurality of CLI measurement resources using the plurality of dedicated tracking loops may include an indication of a maximum quantity of dedicated tracking loops of the first UE for receiving the plurality of CLI measurement resources.

In a forty-eighth aspect, alone or in combination with the forty-sixth and forty-seventh aspects, the indication that the first UE supports concurrent reception of the plurality of CLI measurement resources using the plurality of dedicated tracking loops may include an indication of a maximum quantity of same symbols of the one or more symbols that each of the at least two dedicated tracking loops of the first UE are configured to utilize for receiving the plurality of CLI measurement resources.

In a forty-nineth aspect, alone or in combination with the forty-fifth aspect, the indication to the first UE that the plurality of cross link interference (CLI) measurement resources is within the same CLI measurement resource group of one or more CLI measurement resource groups may include at least that a first plurality of CLI measurement resources are within a first same CLI measurement resource group of the one or more CLI measurement resource groups, and a second plurality of CLI measurement resources are within a second same CLI measurement resource group of the one or more CLI measurement resource groups, and the one or more CLI measurements may be based on a first priority value of the first same CLI measurement resource group and a second priority value of the second same CLI measurement resource group.

In a fiftieth aspect, alone or in combination with the forty-nineth aspect, the first priority value and the second priority value may be assigned by the scheduling entity or determined by the first UE.

In a fifty-first aspect, alone or in combination with the forty-nineth and fiftieth aspects, the first priority value and the second priority value may be determined based on a first distance between the first UE and first source of a first concurrent UL transmission of the at least two concurrent UL transmissions and on a second distance between the first UE and second source of a second concurrent UL transmission of the at least two concurrent UL transmissions.

In a fifty-second aspect, alone or in combination with the forty-nineth through fifty-first aspects, the first priority value may be based on a first power of a first concurrent UL transmission of the at least two concurrent UL transmissions, and the second priority value may be based on a second power of a second concurrent UL transmission of the at least two concurrent UL transmissions.

In one configuration, a user equipment (UE) includes means for receiving, from a scheduling entity, one or more indications of one or more parameters associated with an uplink (UL) transmission from a second UE, where the UL transmission includes one or more cross link interference (CLI) measurement resources, means for configuring one or more dedicated tracking loops for receiving the one or more CLI measurement resources of the UL transmission based on the one or more indications of the one or more parameters, means for receiving, from the second UE, the one or more CLI measurement resources of the UL transmission using the one or more dedicated tracking loops according to the one or more parameters, while also receiving a downlink (DL) transmission from the scheduling entity, means for determining one or more CLI measurements using the one or more CLI measurement resources of the UL transmission, and means for transmitting, to the scheduling entity, a CLI measurement report indicating the one or more CLI measurements associated with the one or more CLI measurement resources of the UL transmission.

In one aspect, the aforementioned means for receiving, from a scheduling entity, one or more indications of one or more parameters associated with an uplink (UL) transmission from a second UE, where the UL transmission includes one or more cross link interference (CLI) measurement resources, means for configuring one or more dedicated tracking loops for receiving the one or more CLI measurement resources of the UL transmission based on the one or more indications of the one or more parameters, means for receiving, from the second UE, the one or more CLI measurement resources of the UL transmission using the one or more dedicated tracking loops according to the one or more parameters, while also receiving a downlink (DL) transmission from the scheduling entity, means for determining one or more CLI measurements using the one or more CLI measurement resources of the UL transmission, and means for transmitting, to the scheduling entity, a CLI measurement report indicating the one or more CLI measurements associated with the one or more CLI measurement resources of the UL transmission may be the processor(s) 1204 shown in FIG. 12 configured to perform the functions recited by the aforementioned means. For example, the aforementioned means for receiving, from a scheduling entity, one or more indications of one or more parameters associated with an uplink (UL) transmission from a second UE, where the UL transmission includes one or more cross link interference (CLI) measurement resources may include the receiving circuitry 1240 and transceiver 1210 shown in FIG. 12. As another example, the aforementioned means for configuring one or more dedicated tracking loops for receiving the one or more CLI measurement resources of the UL transmission based on the one or more indications of the one or more parameters may include the configuring circuitry 1242 and transceiver 1210 shown in FIG. 12. As yet another example, the aforementioned means for receiving, from the second UE, the one or more CLI measurement resources of the UL transmission using the one or more dedicated tracking loops according to the one or more parameters, while also receiving a downlink (DL) transmission from the scheduling entity may include the receiving circuitry 1240 and the transceiver 1210 shown in FIG. 12. As yet another example, the aforementioned means for determining one or more CLI measurements using the one or more CLI measurement resources of the UL transmission may include the determining circuitry 1244 and transceiver 1210 shown in FIG. 12. As yet another example, the aforementioned means for transmitting, to the scheduling entity, a CLI measurement report indicating the one or more CLI measurements associated with the one or more CLI measurement resources of the UL transmission may include the transmitting circuitry 1246 shown in FIG. 12. In another aspect, the aforementioned means may be a circuit or any apparatus configured to perform the functions recited by the aforementioned means.

In one configuration, a scheduling entity includes means for determining one or more parameters associated with an uplink (UL) transmission from a second user equipment (UE), wherein the UL transmission includes one or more cross link interference (CLI) measurement resources, means for transmitting, to a first UE, one or more indications of the one or more parameters associated with the UL transmission for configuring one or more dedicated tracking loops for receiving the one or more CLI measurement resources of the UL transmission, means for transmitting, to the first UE, a downlink (DL) transmission while the second UE transmits the UL transmission, and means for receiving a measurement report from the first UE including one or more CLI measurements obtained from the one or more CLI measurement resources associated with the UL transmission.

In one aspect, the aforementioned means for determining one or more parameters associated with an uplink (UL) transmission from a second user equipment (UE), wherein the UL transmission includes one or more cross link interference (CLI) measurement resources, means for transmitting, to a first UE, one or more indications of the one or more parameters associated with the UL transmission for configuring one or more dedicated tracking loops for receiving the one or more CLI measurement resources of the UL transmission, means for transmitting, to the first UE, a downlink (DL) transmission while the second UE transmits the UL transmission, and means for receiving a measurement report from the first UE including one or more CLI measurements obtained from the one or more CLI measurement resources associated with the UL transmission may be the processor(s) 904 shown in FIG. 9 configured to perform the functions recited by the aforementioned means. For example, the aforementioned means for determining one or more parameters associated with an uplink (UL) transmission from a second user equipment (UE), wherein the UL transmission includes one or more cross link interference (CLI) measurement resources may include the determining circuitry 940 and transceiver 910 shown in FIG. 9. As another example, the aforementioned means for transmitting, to a first UE, one or more indications of the one or more parameters associated with the UL transmission for configuring one or more dedicated tracking loops for receiving the one or more CLI measurement resources of the UL transmission may include the transmitting circuitry 942 and the transceiver 910 shown in FIG. 9. As yet another example, the aforementioned means for transmitting, to the first UE, a downlink (DL) transmission while the second UE transmits the UL transmission may include the transmitting circuitry 942 and the transceiver 910 shown in FIG. 9. As yet another example, the aforementioned means for receiving a measurement report from the first UE including one or more CLI measurements obtained from the one or more CLI measurement resources associated with the UL transmission may include the receiving circuitry 944 and the transceiver 910 shown in FIG. 9. In another aspect, the aforementioned means may be a circuit or any apparatus configured to perform the functions recited by the aforementioned means.

In one configuration, a user equipment (UE) includes means for determining that a plurality of cross link interference (CLI) measurement resources is within a same CLI measurement resource group of one or more CLI measurement resource groups, means for receiving at least two CLI measurement resources of the plurality of CLI measurement resources in one or more same symbols of at least two concurrent uplink (UL) transmissions using at least one dedicated tracking loop, while also receiving a downlink (DL) transmission from a scheduling entity, means determining one or more CLI measurements for the at least two CLI measurement resources based on the at least two CLI measurement resources being received in the one or more same symbols of the at least two concurrent UL transmissions and being within the same CLI measurement resource group of the one or more CLI measurement resource groups.

In one aspect, the aforementioned means for determining that a plurality of cross link interference (CLI) measurement resources is within a same CLI measurement resource group of one or more CLI measurement resource groups, means for receiving at least two CLI measurement resources of the plurality of CLI measurement resources in one or more same symbols of at least two concurrent uplink (UL) transmissions using at least one dedicated tracking loop, while also receiving a downlink (DL) transmission from a scheduling entity, means determining one or more CLI measurements for the at least two CLI measurement resources based on the at least two CLI measurement resources being received in the one or more same symbols of the at least two concurrent UL transmissions and being within the same CLI measurement resource group of the one or more CLI measurement resource groups may be the processor(s) 1204 shown in FIG. 12 configured to perform the functions recited by the aforementioned means. For example, the aforementioned means for determining that a plurality of cross link interference (CLI) measurement resources is within a same CLI measurement resource group of one or more CLI measurement resource groups may include the determining circuitry 1244 shown in FIG. 12. As another example, the aforementioned means for receiving at least two CLI measurement resources of the plurality of CLI measurement resources in one or more same symbols of at least two concurrent uplink (UL) transmissions using at least one dedicated tracking loop, while also receiving a downlink (DL) transmission from a scheduling entity may include the receiving circuitry 1240 and transceiver 1210 shown in FIG. 12. As yet another example, the aforementioned means for determining one or more CLI measurements for the at least two CLI measurement resources based on the at least two CLI measurement resources being received in the one or more same symbols of the at least two concurrent UL transmissions and being within the same CLI measurement resource group of the one or more CLI measurement resource groups may include the determining circuitry 1244 shown in FIG. 12. In another aspect, the aforementioned means may be a circuit or any apparatus configured to perform the functions recited by the aforementioned means.

In one configuration, a scheduling entity includes means for transmitting an indication to a first use equipment (UE) that a plurality of cross link interference (CLI) measurement resources is within a same CLI measurement resource group of one or more CLI measurement resource groups, means for transmitting a downlink (DL) transmission to the first UE when the first UE receives at least two CLI measurement resources of the plurality of CLI measurement resources in one or more same symbols of at least two concurrent uplink (UL) transmissions using at least one dedicated tracking loop, and means for receiving a CLI measurement report including one or more CLI measurements for the at least two CLI measurement resources based on the at least two CLI measurement resources being received in the one or more same symbols of the at least two concurrent UL transmissions and being within the same CLI measurement resource group of the one or more CLI measurement resource groups.

In one aspect, the aforementioned means for transmitting an indication to a first use equipment (UE) that a plurality of cross link interference (CLI) measurement resources is within a same CLI measurement resource group of one or more CLI measurement resource groups, means for transmitting a downlink (DL) transmission to the first UE when the first UE receives at least two CLI measurement resources of the plurality of CLI measurement resources in one or more same symbols of at least two concurrent uplink (UL) transmissions using at least one dedicated tracking loop, and means for receiving a CLI measurement report including one or more CLI measurements for the at least two CLI measurement resources based on the at least two CLI measurement resources being received in the one or more same symbols of the at least two concurrent UL transmissions and being within the same CLI measurement resource group of the one or more CLI measurement resource groups may be the processor(s) 904 shown in FIG. 9 configured to perform the functions recited by the aforementioned means. For example, the aforementioned means for transmitting an indication to a first use equipment (UE) that a plurality of cross link interference (CLI) measurement resources is within a same CLI measurement resource group of one or more CLI measurement resource groups may include the transmitting circuitry 942 and transceiver 910 shown in FIG. 9. As another example, the aforementioned means for transmitting a downlink (DL) transmission to the first UE when the first UE receives at least two CLI measurement resources of the plurality of CLI measurement resources in one or more same symbols of at least two concurrent uplink (UL) transmissions using at least one dedicated tracking loop may include the transmitting circuitry 942 and the transceiver 910 shown in FIG. 9. As yet another example, the aforementioned means for receiving a CLI measurement report including one or more CLI measurements for the at least two CLI measurement resources based on the at least two CLI measurement resources being received in the one or more same symbols of the at least two concurrent UL transmissions and being within the same CLI measurement resource group of the one or more CLI measurement resource groups may include the receiving circuitry 944 and the transceiver 910 shown in FIG. 9. In another aspect, the aforementioned means may be a circuit or any apparatus configured to perform the functions recited by the aforementioned means.

Several aspects of a wireless communication network have been presented with reference to an exemplary implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-7, 8A, 8B, and 9-14 may be rearranged and/or combined into a single component, step, feature, or function or embodied in several components, steps, or functions. Additional elements, components, steps, and/or functions may also be added without departing from novel features disclosed herein. The apparatus, devices, and/or components illustrated in FIGS. 1-4, 7, 8A, 9, and 12 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b, and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

What is claimed is:

1. A method of wireless communication at a first user equipment (UE), comprising:
receiving, from a scheduling entity, one or more indications of one or more parameters associated with an uplink (UL) transmission from a second UE, wherein the UL transmission includes one or more cross link interference (CLI) measurement resources;
configuring one or more dedicated tracking loops for receiving the one or more CLI measurement resources of the UL transmission based on the one or more indications of the one or more parameters;
receiving, from the second UE, the one or more CLI measurement resources of the UL transmission using the one or more dedicated tracking loops according to the one or more parameters, while also receiving a downlink (DL) transmission from the scheduling entity; and
determining one or more CLI measurements using the one or more CLI measurement resources of the UL transmission.

2. The method of claim 1, further comprising:
transmitting, to the scheduling entity, a CLI measurement report indicating the one or more CLI measurements associated with the one or more CLI measurement resources of the UL transmission.

3. The method of claim 1, wherein the one or more indications of the one or more parameters associated with the UL transmission comprises:
at least one indication of one or more changed parameters associated with the UL transmission.

4. The method of claim 1, wherein the one or more parameters comprise at least one of:
a power of at least one CLI measurement resource of the one or more CLI measurement resources,
a frequency of at least one CLI measurement resource of the one or more CLI measurement resources, or
a timing advance of at least one CLI measurement resource of the one or more CLI measurement resources.

5. The method of claim 4, wherein when the one or more parameters comprise at least the power of the at least one CLI measurement resource of the one or more CLI measurement resources, further comprising:
abstaining, for a predetermined duration of time, from receiving one or more CLI measurements using the at least one CLI measurement resources of the UL transmission when the power exceeds a threshold power difference from a previous power.

6. The method of claim 1, wherein the one or more indications of the one or more parameters comprise:
a first indication of a first parameter associated with a first dedicated tracking loop of the one or more dedicated tracking loops; and
a second indication of a second parameter associated with a second dedicated tracking loop of the one or more dedicated tracking loops.

7. The method of claim 1, wherein the one or more indications of the one or more parameters comprise:
at least one indication of a plurality of parameters associated with at least one dedicated tracking loop of the one or more dedicated tracking loops.

8. The method of claim 1, wherein the one or more indications of the one or more parameters associated with an UL transmission from a second UE is received from the scheduling entity via at least one of a medium access control (MAC) control element (MAC-CE), a physical downlink control channel (PDCCH), or a radio resource control (RRC) message.

9. A user equipment (UE) for wireless communication in a wireless communication network, comprising:
a wireless transceiver;
a memory; and
a processor communicatively coupled to the wireless transceiver and the memory, wherein the processor and the memory are configured to:
receive, from a scheduling entity, one or more indications of one or more parameters associated with an uplink (UL) transmission from a second UE, wherein the UL transmission includes one or more cross link interference (CLI) measurement resources,
configure one or more dedicated tracking loops for receiving the one or more CLI measurement resources of the UL transmission based on the one or more indications of the one or more parameters,
receive, from the second UE, the one or more CLI measurement resources of the UL transmission using the one or more dedicated tracking loops according to the one or more parameters, while also receiving a downlink (DL) transmission from the scheduling entity, and
determine one or more CLI measurements using the one or more CLI measurement resources of the UL transmission.

10. The UE of claim 9, wherein the processor and the memory are further configured to:
transmit, to the scheduling entity, a CLI measurement report indicating the one or more CLI measurements associated with the one or more CLI measurement resources of the UL transmission.

11. The UE of claim 9, wherein the one or more indications of the one or more parameters associated with the UL transmission comprises:
at least one indication of one or more changed parameters associated with the UL transmission.

12. The UE of claim 9, wherein the one or more parameters comprise at least one of:
a power of at least one CLI measurement resource of the one or more CLI measurement resources,
a frequency of at least one CLI measurement resource of the one or more CLI measurement resources, or
a timing advance of at least one CLI measurement resource of the one or more CLI measurement resources.

13. The UE of claim 12, wherein when the one or more parameters comprise at least the power of the at least one CLI measurement resource of the one or more CLI measurement resources, the processor and the memory are further configured to:
abstain, for a predetermined duration of time, from receiving one or more CLI measurements using the at least one CLI measurement resources of the UL transmission when the power exceeds a threshold power difference from a previous power.

14. The UE of claim 9, wherein the one or more indications of the one or more parameters comprise:
a first indication of a first parameter associated with a first dedicated tracking loop of the one or more dedicated tracking loops; and
a second indication of a second parameter associated with a second dedicated tracking loop of the one or more dedicated tracking loops.

15. The UE of claim 9, wherein the one or more indications of the one or more parameters comprise:
at least one indication of a plurality of parameters associated with at least one dedicated tracking loop of the one or more dedicated tracking loops.

16. The UE of claim 9, wherein the one or more indications of the one or more parameters associated with an UL transmission from a second UE is received from the scheduling entity via at least one of a medium access control (MAC) control element (MAC-CE), a physical downlink control channel (PDCCH), or a radio resource control (RRC) message.

17. A method of wireless communication at a scheduling entity, comprising:
determining one or more parameters associated with an uplink (UL) transmission from a second user equipment (UE), wherein the UL transmission includes one or more cross link interference (CLI) measurement resources;
transmitting, to a first UE, one or more indications of the one or more parameters associated with the UL transmission for configuring one or more dedicated tracking loops for receiving the one or more CLI measurement resources of the UL transmission;
transmitting, to the first UE, a downlink (DL) transmission while the second UE transmits the UL transmission; and
receiving a measurement report from the first UE including one or more CLI measurements obtained from the one or more CLI measurement resources associated with the UL transmission.

18. The method of claim 17, wherein the one or more indications of the one or more parameters associated with the UL transmission comprises:
at least one indication of one or more changed parameters associated with the UL transmission.

19. The method of claim 17, wherein the one or more parameters comprise at least one of:
a power of at least one CLI measurement resource of the one or more CLI measurement resources,
a frequency of at least one CLI measurement resource of the one or more CLI measurement resources, or
a timing advance of at least one CLI measurement resource of the one or more CLI measurement resources.

20. The method of claim 17, wherein the one or more indications of the one or more parameters comprise:
a first indication of a first parameter associated with a first dedicated tracking loop of the one or more dedicated tracking loops; and
a second indication of a second parameter associated with a second dedicated tracking loop of the one or more dedicated tracking loops.

21. The method of claim 17, wherein the one or more indications of the one or more parameters comprise:
at least one indication of a plurality of parameters associated with at least one dedicated tracking loop of the one or more dedicated tracking loops.

22. The method of claim 17, wherein the one or more indications of the one or more parameters associated with an UL transmission from a second UE is transmitted by the scheduling entity via at least one of a medium access control (MAC) control element (MAC-CE), a physical downlink control channel (PDCCH), or a radio resource control (RRC) message.

23. The method of claim 17, wherein the one or more indications are included in transmission configuration indicator (TCI) state information.

24. A base station for wireless communication in a wireless communication network, comprising:
a wireless transceiver;
a memory; and
a processor communicatively coupled to the wireless transceiver and the memory, wherein the processor and the memory are configured to:
determine one or more parameters associated with an uplink (UL) transmission from a second user equipment (UE), wherein the UL transmission includes one or more cross link interference (CLI) measurement resources,
transmit, to a first UE, one or more indications of the one or more parameters associated with the UL transmission for configuring one or more dedicated tracking loops for receiving the one or more CLI measurement resources of the UL transmission,
transmit, to the first UE, a downlink (DL) transmission while the second UE transmits the UL transmission; and
receive a measurement report from the first UE including one or more CLI measurements obtained from the one or more CLI measurement resources associated with the UL transmission.

25. The scheduling entity of claim 24, wherein the one or more indications of the one or more parameters comprise:
at least one indication of a plurality of parameters associated with at least one dedicated tracking loop of the one or more dedicated tracking loops.

26. The scheduling entity of claim 24, wherein the one or more indications of the one or more parameters associated with an UL transmission from a second UE is transmitted by the scheduling entity via at least one of a medium access control (MAC) control element (MAC-CE), a physical downlink control channel (PDCCH), or a radio resource control (RRC) message.

27. The scheduling entity of claim 24, wherein the one or more indications are included in transmission configuration indicator (TCI) state information.

28. The scheduling entity of claim 24, wherein each dedicated tracking loop of the one or more dedicated tracking loops is associated with a single CLI measurement resource of the one or more CLI measurement resources.

29. The scheduling entity of claim 24, wherein each dedicated tracking loop of the one or more dedicated tracking loops is associated with a plurality of CLI measurement resources of the one or more CLI measurement resources.

30. The scheduling entity of claim 24, wherein determining the one or more parameters associated with the UL transmission comprises:
scheduling the one or more parameters associated with the UL transmission.
